(19) United States
(12) Patent Application Publication
(10) Pub. No.: US 2026/0316596 A1
(43) Pub. Date: Oct. 15, 2026

(54) GLOBAL COORDINATION OF ENERGY DISTRIBUTION TO SUBSYSTEMS IN BATTERY ELECTRIC VEHICLE

(71) Applicant: DENSO CORPORATION, Kariya-shi (JP)

(72) Inventors: Ron PUTS, Wegberg (DE); Rachel CHAO, Wegberg (DE); Pietro MOSCA, Wegberg (DE)

(73) Assignee: DENSO CORPORATION, Kariya-shi (JP)

(21) Appl. No.: 19/465,365

(22) Filed: Jan. 30, 2026

Related U.S. Application Data
(63) Continuation of application No. PCT/JP2024/026270, filed on Jul. 23, 2024.

(30) Foreign Application Priority Data
Aug. 4, 2023 (DE) 102023120726.1

(51) Int. Cl. B60L 50/60; B60L 1/00; B60L 1/08

(52) U.S. Cl. CPC B60L 50/60; B60L 1/003; B60L 1/08; B60L 2240/12; B60L 2240/14; B60L 2240/545; B60L 2240/547; B60L 2240/642; B60L 2240/662; B60L 2250/16

(57) ABSTRACT

Distribution of energy between subsystems in a battery electric vehicle is globally coordinated based on a computed energy consumption trajectory for a predetermined route of the battery electric vehicle. The subsystems include at least an electric powertrain, a cooling system, and a cabin air conditioning system. A coordination system layer is above an optimization system layer and a component control system layer. Energy available is distributed in a battery of the vehicle to the subsystems in a coordinated manner based on a coordination function using the system inputs based on a cost function considering a must/want specification for energy to be provided to the subsystems via the optimization system layer so as to maximize a user satisfaction for a user of the vehicle while driving and at the same time reach a driving destination on the predetermined route with a predetermined remaining state of charge of the battery.

### CROSS REFERENCE TO RELATED APPLICATIONS

The present application is a continuation application of International Patent Application No. PCT/JP2024/026270 filed on Jul. 23, 2024, which designated the U.S. and claims the benefit of priority from German Patent Application No. 102023120726.1 filed on Aug. 4, 2023. The entire disclosure of the above application is incorporated herein by reference.

### TECHNICAL FIELD

The disclosure relates to global coordination of the distribution of energy or power available in a battery of a battery electric vehicle (BEV).

### BACKGROUND

One of the reasons for not buying and often rejecting battery electric vehicles (BEVs) is inconsistent performance in the eyes of potential customers. For example, it is widely known that range specifications for a BEV, e.g., 400 km, by manufacturers or in sales brochures are only achievable in special driving cycles or under optimal conditions, but practically achievable ranges for the customer are usually far below this and only amount to e.g., 280 km.

Thus, prioritizing user satisfaction is a critical factor in coordinating available energy in BEVs to ensure efficient and reliable energy supply, which should be considered when developing control logic to coordinate energy distribution in BEVs.

### SUMMARY

According to at least one embodiment of the present disclosure, a system is for global coordination of distribution of energy between subsystems in a battery electric vehicle having a modular control architecture based on a computed energy consumption trajectory for a predetermined route of the battery electric vehicle. The subsystems include at least an electric drive train, a cooling system and a cabin air conditioning system. The system includes at least one processor with at least one memory storing computer program code executable by the at least one processor. The at least one processor is configured to receive system inputs. The system inputs include at least a cabin thermal energy trajectory based on environment conditions and temperature setting, an electrical energy trajectory based on a vehicle specification and route, and a battery thermal energy trajectory based on battery thermal behavior and safety constraints. The at least one processor is configured to implement a coordination system layer, an optimization system layer disposed below the coordination system layer, and a component control system layer associated with the subsystems and disposed below the optimization system layer. The optimization system layer is configured to determine and optimize energy supply to the subsystems locally in the battery electric vehicle by intelligent thermal management while monitoring a respective state of the subsystems. The at least one processor is configured to distribute energy available in a battery of the battery electric vehicle on a basis of a coordination function using the system inputs based on a cost function taking into account a must/want specification for energy to be provided to the subsystems via the optimization system layer as coordinated electrical energy available for the electric drive train, electrical energy available for cabin conditioning and electrical energy available for battery conditioning to the subsystems in such a way that a) a user satisfaction comprising at least comfort, driving pleasure and/or convenience is maximized for a user or driver of the battery electric vehicle during journey and, at the same time, b) a destination is reached on the predetermined route with a predetermined remaining state of charge of the battery of the battery electric vehicle.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a diagram illustrating an example of a modular control architecture for a BEV.

FIG. 2 is a diagram illustrating a layered model represented in the modular control architecture for a BEV, according to an embodiment of the disclosure.

FIG. 3 is a diagram illustrating an overview of smart thermal management in a BEV, according to an embodiment of the disclosure.

FIG. 4 is a diagram illustrating an overview of a global coordination by vehicle energy management in a BEV, according to an embodiment of the disclosure.

FIG. 5A is an illustration of global coordination with prioritization in a BEV, according to an embodiment of the disclosure.

FIG. 5B is a diagram illustrating global coordination with prioritization in a BEV, according to an embodiment of the disclosure.

FIG. 6A is an illustration of global coordination with prioritization in a BEV, according to an embodiment of the disclosure. according to an embodiment of the disclosure.

FIG. 6B is an illustration of global coordination with prioritization in a BEV, according to an embodiment of the disclosure. according to an embodiment of the disclosure.

FIG. 7A is an illustration of global coordination with prioritization in a BEV, according to an embodiment of the disclosure.

FIG. 7B is an illustration of global coordination with prioritization in a BEV, according to an embodiment of the disclosure.

FIG. 8A is an illustration of energy demand used in FIG. 8D, according to an embodiment of the disclosure.

FIG. 8B is an illustration of energy available used in FIG. 8D, according to an embodiment of the disclosure.

FIG. 8C is an illustration of driver settings used in FIG. 8D, according to an embodiment of the disclosure.

FIG. 8D is an illustration of quantified benefits of global coordination in a BEV, according to an embodiment of the disclosure.

FIG. 9A is an illustration relating to an exemplary core functionality of global coordination with respect to avoiding a critical state of charge, according to an embodiment of the disclosure.

FIG. 9B is an illustration relating to an exemplary core functionality of global coordination with respect to avoiding a critical state of charge, according to an embodiment of the disclosure.

FIG. 9C is an illustration relating to an exemplary core functionality of global coordination with respect to avoiding a critical state of charge, according to an embodiment of the disclosure.

FIG. 10A is an illustration relating to a conventional prioritization.

FIG. 10B is an illustration relating to an exemplary smart cabin prioritization by global coordination, according to an embodiment of the disclosure.

FIG. 11A is an illustration relating to a conventional ECO mode.

FIG. 11B is an illustration relating to an exemplary smart ECO mode by global coordination, according to an embodiment of the disclosure.

FIG. 12A is an illustration relating to a conventional state-of-charge prediction.

FIG. 12B is an illustration relating to an exemplary smart charging state quality monitoring by global coordination, according to an embodiment of the disclosure.

FIG. 13A is a definition of input signals for or system inputs to global coordination, according to an embodiment of the disclosure.

FIG. 13B is an illustration of an example of cabin temperature trajectory generation for global coordination, according to an embodiment of the disclosure.

FIG. 13C is an illustration of an example of battery temperature trajectory generation for global coordination, according to an embodiment of the disclosure.

FIG. 14A is an exemplary definition of a cost function in global coordination, according to an embodiment of the disclosure.

FIG. 14B is illustration of prioritization using an exemplary definition of a cost function in global coordination, according to an embodiment of the disclosure.

FIG. 15A is an exemplary selection of an algorithm for global coordination, according to an embodiment of the disclosure.

FIG. 15B is illustration of dynamic programming used in FIG. 15A, according to an embodiment of the disclosure.

FIG. 16 is an illustrative diagram showing an exemplary connection of the global coordination to a local optimization layer in the BEV, according to an embodiment of the disclosure.

### DETAILED DESCRIPTION

Comparative examples coordinating energy distribution in BEVs offers a number of features to increase user satisfaction. These include, for example, algorithms that seek to optimize energy efficiency while taking into account the needs of users, such as the distance that still needs to be traveled and the state of charge of the BEV. This is often only insufficiently successful.

For example, people generally tend to recharge the battery of their BEV early on, before a state of charge that is too low is reached. For example, people most often recharge when the battery's state of charge is still between 30% and 50%. In addition, controls include predictive (i.e., rule-based) features that are not optimal and/or BEV manufacturers prioritize passenger cabin comfort at the expense of powertrain performance and battery state of charge.

If, for example, the user of a BEV begins a journey to a destination with a sufficient state of charge (SoC) and the range displayed to him at this point suggests that the destination will be reached without recharging, but this range then decreases inconsistently but disproportionately after a short journey in such a way that the user must either fear that he will not reach his destination as planned or must make an unscheduled charging stop in order to reach his destination at all, it is obvious that the user will not be satisfied.

The present disclosure provides, in a BEV, a more intelligent allocation and/or distribution of energy or power available in a battery of the BEV to vehicle core functionalities.

In addition, the disclosure is intended to improve range reliability and thus convenience by more accurately predicting a range displayed to a user of a BEV at the beginning of a trip of the BEV, to provide optimal power distribution and thus improve the range of the BEV, and to increase the flexibility of driving comfort and thus increase convenience and driving fun, or fun to drive. Last but not least, the disclosure is also intended to improve the usability of a BEV by adhering to a planned route while meeting user satisfaction goals.

The aforementioned task is solved by a system comprising means for globally coordinating the distribution of power between subsystems in a battery electric vehicle having a modular control architecture. Advantageous further embodiments of the disclosure are the subject of the appended subclaims.

An initial challenge for BEVs is accurately predicting or forecasting range. An inaccurate indication of expected range can lead to increased range anxiety, stress and quality for a user when driving a BEV. Very long trips, in particular, are more difficult to plan because of the charging operations required. To be consistent while driving, it is important to predict what could or would happen during the trip in terms of the vehicle's powertrain and thermal management, taking into account the chosen route, traffic, and weather conditions (disturbances).

A second challenge for BEVs is to maximize BEV reliability by sticking to the planned route while meeting user satisfaction goals. This is achieved by prioritizing the maximum range, reducing the impact of charging operations, and meeting the minimum user requirements regardless of variations in environmental conditions or driver decisions.

According to an idea generally underlying the disclosure, a higher-level control layer, hereinafter referred to as “global coordination,” is introduced into the control system of the BEV to allow smart or intelligent allocation or distribution of energy or power available in the battery of the BEV toward core vehicle functionalities.

Specifically, in accordance with one aspect of the present disclosure, a system is provided having a means for globally coordinating the distribution of power between subsystems in a battery electric vehicle having a modular control architecture based on a computed power consumption trajectory for a predetermined route of the battery electric vehicle, wherein the subsystems include at least an electric powertrain, a cooling system, and a cabin air conditioning system; wherein the means for global coordination has a plurality of system inputs, the plurality of system inputs including at least a cabin thermal energy trajectory based on environment conditions and temperature setting, an electrical energy trajectory based on a vehicle specification (i.e. the weight) and the route, and a battery thermal energy trajectory based on the battery thermal behavior and safety constraints (i.e. the prevention of an excessive battery condition); the means for performing the global coordination is associated with a coordination system layer; an optimization system layer is disposed below the coordination system layer; and the subsystems are associated with a component control system layer below the optimization system layer, wherein the optimization system layer is arranged to optimize the power supply to the subsystems determined by the means for performing the global coordination locally in the battery electric vehicle by means of intelligent thermal management while monitoring a respective state of the subsystems; and the means for performing the global coordination is arranged to optimize the energy available in a battery of the battery electric vehicle based on a coordination function using the system inputs based on a cost function taking into account a target/desired, or must/want, energy to be provided to the subsystems via the optimization system layer as electric energy available in a coordinated manner to the electric drive train, electrical energy available for cabin conditioning and electrical energy available for battery conditioning to the subsystems in such a way that a) a user satisfaction comprising at least comfort, driving pleasure and/or convenience is maximized for a user or driver of the battery electric vehicle during the journey and, at the same time, b) a destination is reached on the predetermined route with a predetermined remaining state of charge of the battery of the battery electric vehicle.

It is noted that the battery of the BEV may be an energy storage device thereof designated as usual, the subsystems of the BEV may include any auxiliaries that provide core functionalities of the BEV and/or retrieve a predetermined amount of energy or power from the battery, the cabin conditioning may include air conditioning of the cabin (cooling/heating), and the must/want specification may include a setpoint or fixed value as a target and a corresponding remaining optional value (in terms of maximum and minimum or must/want) may be included. It is understood that a must/want value or parameter pair refers to a maximum of the total energy available in the battery.

According to a second aspect of the present disclosure, which is dependent on the preceding first aspect, in the system, the plurality of system inputs to the means for performing the global coordination further comprise: a battery initial state of charge, which is the state of charge of the battery at the beginning of a trip; a battery final state of charge, which is the predetermined remaining state of charge of the battery upon reaching the destination of the trip; settings and/or weighting factors for the cost function, wherein the settings and/or weighting factors are predeterminable as a user preference and/or a user prioritization via a human-machine interface; and the must/want specification, wherein the must/want specification is predeterminable as a user preference and/or a user prioritization via the human-machine interface.

According to a third aspect of the present disclosure, which depends on the preceding first or second aspect, an energy demand computation for the energy consumption trajectory along the route comprises at least: a route energy demand prediction for the electric powertrain of the battery electric vehicle, wherein the requested energy is electric energy; a route energy demand prediction for the cabin of the battery electric vehicle, wherein the requested energy is thermal energy; and/or a route energy demand prediction for the battery of the battery electric vehicle, wherein the requested energy is thermal energy.

According to a fourth aspect of the present disclosure, which is dependent on the preceding third aspect, for a route energy demand prediction computation for the electric powertrain, in the energy demand computation, a vehicle model generates an electric power demand for the electric powertrain of the battery electric vehicle based on the vehicle speed, the vehicle acceleration, and a gradient of a road, which is used in conjunction with the battery thermal energy trajectory in the global coordination.

According to a fifth aspect of the present disclosure, which depends on the third aspect, for a route energy demand prediction computation for the cabin, in the energy demand computation, a cabin thermal energy trajectory generator generates a cabin thermal energy trajectory based on an actual temperature of the cabin and a target temperature of the cabin; and the cabin thermal energy trajectory, together with the ambient temperature and the vehicle speed, is fed to an inverse cabin thermal model, at the output of which the cabin conditioning thermal power demand is output, which, in conjunction with the vehicle speed, is input to the global coordination.

According to a sixth aspect of the present disclosure, which depends on the third aspect, for a route energy demand prediction computation for the battery, in the energy demand computation, a battery thermal energy trajectory generator generates a battery thermal energy trajectory based on an actual temperature of the battery and a target temperature of the battery; and the battery thermal energy trajectory together with the vehicle speed is fed to an inverse battery thermal model, at the output of which a battery conditioning thermal power demand is output, which is input to the global coordination.

According to a seventh aspect of the present disclosure, which depends on any of the preceding third through sixth aspects, the system is arranged to perform a conversion of thermal power to electrical power in the energy demand computation or in the global coordination.

According to an eighth aspect of the present disclosure, which depends on any of the preceding first through seventh aspects, in the global coordination, the cost function includes optimizing a control task using a MUST/WANT logic, with a must portion to be provided to an energy requesting subsystem of the system to ensure a certain minimum level of user satisfaction, and a want portion to be optionally provided to the subsystem, to maximize the degree of user satisfaction, and a user prioritization is directly coupled to the cost function and defined by means of dynamic weights a meaning of different contributions in the cost function, the different contributions comprising at least one user satisfaction regarding comfort, propulsion and/or electrical performance of or for the subsystems of the battery electric vehicle during use thereof.

According to a ninth aspect of the present disclosure, which depends on the eighth aspect, a split between the must portion and the want portion is determinable by means of calibration or based on a predetermined prioritization with respect to comfort, convenience, and/or driving fun or pleasure.

According to a tenth aspect of the present disclosure, which depends on any of the preceding first through ninth aspects, in the global coordination, the cost function is computed using dynamic programming, wherein the dynamic programming checks in the backward direction from an end time to an initial time whether a computed end state is achievable, and if so, determines in the forward direction from the initial time to the end time a loading state trajectory that provides best user satisfaction at lowest cost in accordance with the cost function.

According to an eleventh aspect of the present disclosure, which depends on any of the preceding first through tenth aspects, global coordination comprises a smart cabin prioritization predeterminable by means of a stronger comfort weighting by a driver at a human-machine interface, a smart eco-mode that limits power for heating/cooling the cabin and maximum propulsion power, and/or a smart state-of-charge quality monitor arranged to correct an inaccurate state-of-charge prediction for reaching a destination to a more accurate value.

According to a twelfth aspect, which depends from any of the preceding first to eleventh aspects, the system comprises at least the battery provided in the form of an energy storage device and arranged to store electric energy and to supply electric energy to the battery electric vehicle, and at least one heating device, at least one refrigerant circuit, and at least one coolant circuit arranged to condition a cabin of the battery electric vehicle and to condition the battery and an electric drive train of the battery electric vehicle by heating and/or cooling.

The aforementioned global coordination may be implemented in a BEV, without being limited thereto, as software, hardware, a combination of software and hardware, logic arrangements, a system, one or more modules, means, facilities and/or devices, or a combination thereof. Further, a corresponding method may implement, without being limited thereto, corresponding operations in software, hardware, a combination of software and hardware, logic arrangements, a system, one or more modules, means, facilities, and/or devices, or a combination thereof.

In the foregoing context, and without being limited thereto, core ideas of the disclosure in the context of the general underlying idea include the followings.

a) An end-state condition—to meet user requirements for end-state reliability, the end-state of the BEV has the highest priority. For example, the total energy consumption at the end of a trip is set to a value proposed at the beginning of the trip (i.e., it is reflected in the state of charge (SoC)). For example, the total energy consumption can be set by specifying a minimum SoC at the end of the trip, e.g., 20%, which is to be maintained.

b) A route-based vehicle trajectory or vehicle locomotion trajectory—when a route is input by a user, the endpoints of a control task are determined and enable optimization in accordance with a cost function. For example, an energy consumption trajectory or energy consumption evolution curve for the route is computed using information from the vehicle, predictive inputs, models (e.g., inverse, statistical, data-driven models, neural networks), etc.

c) A cost function considering a “must/want” principle, i.e., a combination or pair of a fixed target or goal value to be met and a value selectable beyond that within the limits of the maximum energy or power available, and user preference—an (optimization) cost function based on user preference and user-perceived satisfaction (the relationship between what is desired and what is achieved). For example, a user prioritized energy balance (i.e., driving fun, comfort, convenience) and a minimum satisfaction requirement (e.g., how much energy is absolutely necessary to reach the destination, to avoid damage to components, to avoid extreme inconvenience in the cabin, etc.) are input to a human-machine interface (HMI; human-machine interface) coupled to the system or derived from a user history and are primary components of the optimization cost function.

d) An optimization algorithm—a suitably chosen optimization algorithm is fundamental to the solution of a control task at hand. For example, a combination of MPC (Model Predictive Control), DP (Dynamic Programming), and PMP (Pontryagin's Maximum Principle) is used to solve a proposed problem or task with multiple states, multiple inputs, and bounded end states. The task is first solved backward (from the end point to the start point) to verify that it is possible to reach the computed end state, and then the optimal control policy is determined forward (from the start point to the end point) by tracking the lowest cumulative cost over the entire trip.

e) A regularly updated vehicle control system—in order to maintain the proposed vehicle trajectory and to meet the end state specification, regular updating (feedback of the current state and computation of a new trajectory) is required. For example, at the end of each of previously determined (defined) sections of the trip (based on the route information), the energy consumption for the section is computed and fed back into the computation of the original vehicle trajectory. The new or next vehicle trajectory is computed using an optimization algorithm and the new energy targets are passed to the vehicle controller.

Further features are possible in modifications of the disclosure as described below.

f) A segmentation algorithm—to simplify the vehicle trajectory computation, a segmentation algorithm can be used to reduce the state computation requirements by simplifying the optimization time domain from real-time (instantaneous optimization) to one segment (discrete optimization). For example, segmenting a route by road type (city, highway, rural) and/or vehicle speed (low, medium, high) to compute the average power consumption for a given segment and using the average power to compute the total power consumption for a given segment type and duration can be performed.

g) A pre-computed vehicle route—if the vehicle route is not entered by the user, information from the vehicle inventory, historical user data, predictive inputs, and models can be used to predict the route and to compute a “best estimate” for the vehicle trajectory. For example, when a vehicle route for commuting is determined using location data and time information, the vehicle route and an optimization control can then be selected to achieve the predicted user satisfaction.

h) A non-conditional vehicle trajectory—in the event that no user-entered or predicted route information is available, the control can still be used by determining other end state constraints. For example, the total energy remaining in the battery can be used as the end state constraint.

i) In the absence of user input from the human-machine interface or user history, user responses in the vehicle can be used to determine the optimization desired by the user. For example, a larger pedal stroke or a higher temperature demand (maximum heat) can be used to determine the minimum energy (i.e., its must or want value) required for user satisfaction.

j) A vehicle trajectory computation in the location domain—as an alternative to the vehicle trajectory computation in the time domain (i.e., optimization based on predicted power over time: energy consumption), optimization based on predicted energy over distance can be used to reduce the priority of meeting the estimated time of arrival (ETA; estimated time of arrival). For example, control updates by location (called geo-gates) can be scheduled instead.

As mentioned at the outset, driver or user preferences are integrated into core vehicle functions to increase driver or user satisfaction, avoid critical battery operation, and improve the quality of the user's battery state of charge. Preferably, performance/energy optimization is distributed over the entire route.

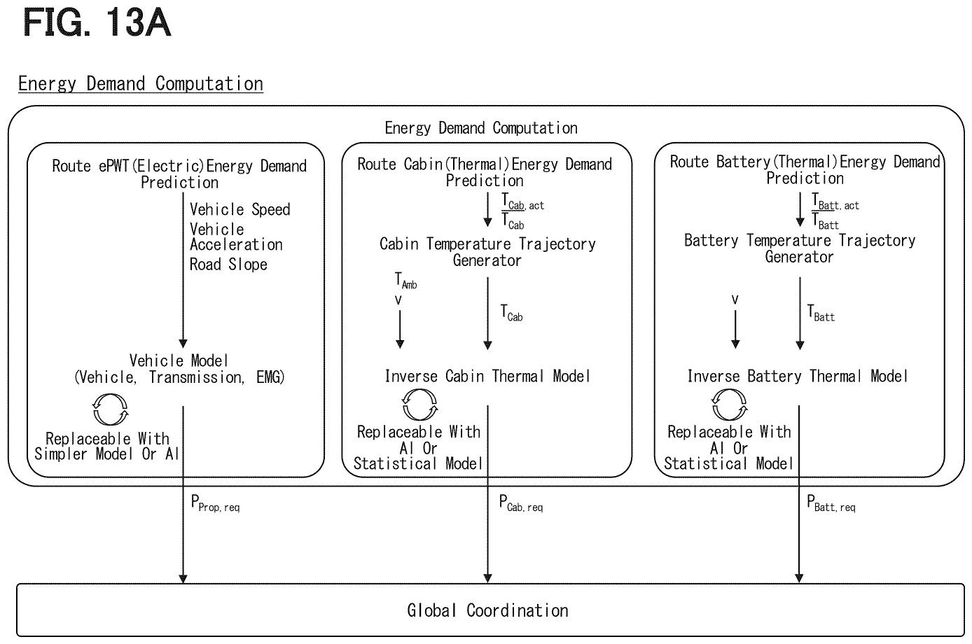

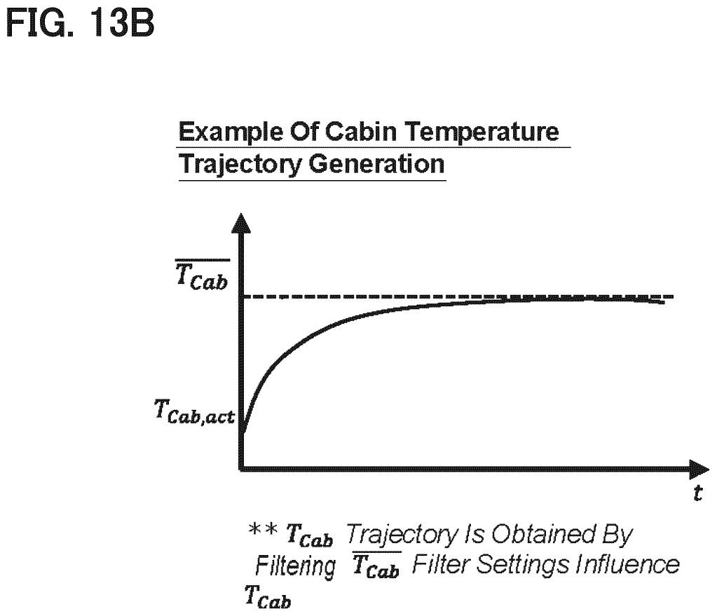

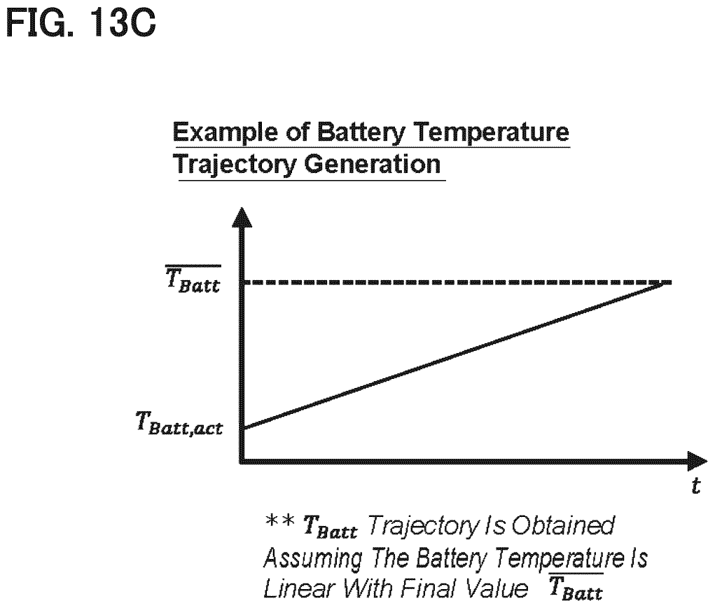

It is noted that herein the terms “power” and “energy” are used in equivalent form. For the person skilled in the art, it is understood that in a BEV both power (for example, for the drive train, indicated in kW) and energy (for example, for air conditioning) can be requested and flow, with the battery of the BEV supplying this power or energy and power and energy being convertible into each other to this extent and equivalent in this sense. In FIG. 13A, which is yet to be described, such a conversion is explicitly noted for system inputs into global coordination.

The increasing complexity of controlling the vehicle's thermal system is managed by a distributed approach within a modular control architecture.

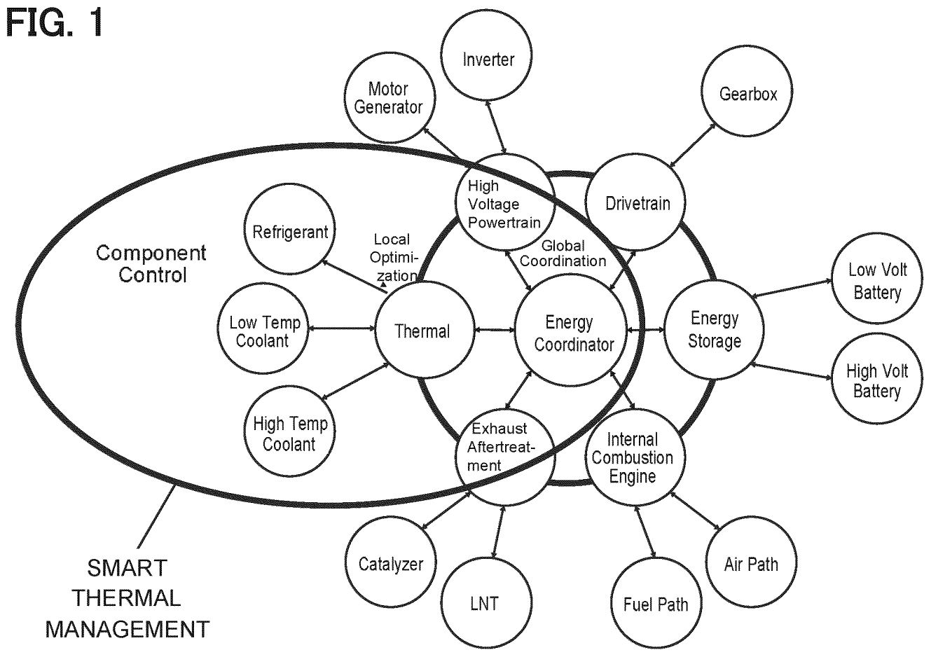

FIG. 1 shows an introductory example of such a modular control architecture for a BEV. Shown are subsystems as might typically be present in a BEV or the like. An energy coordinator globally coordinates and distributes between core functionalities, such as battery, powertrain, thermal or heat-related, etc. In particular, the elliptically outlined thermal domain is considered herein, in which global coordination of energy and/or power from the battery of a BEV is performed in conjunction with intelligent or smart thermal or heat management.

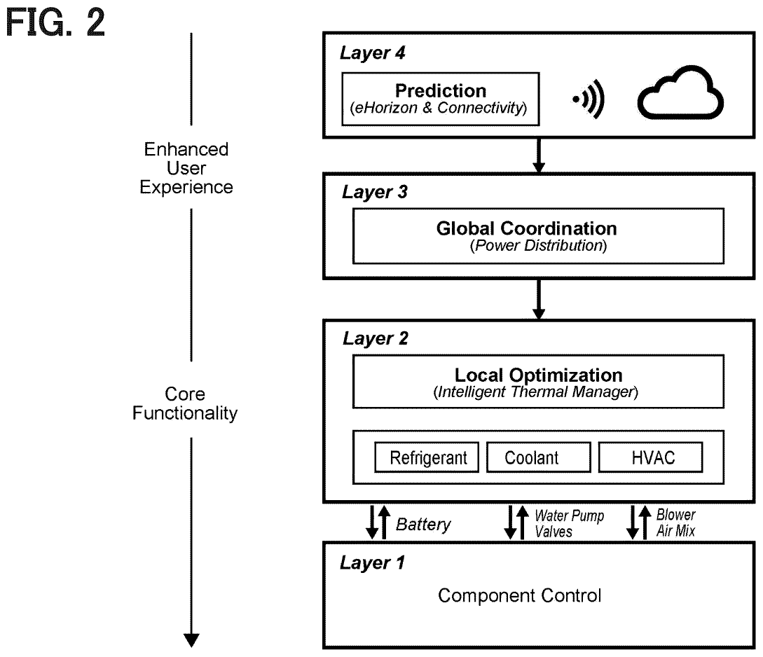

FIG. 2 shows a layered model of a multilayered structure represented in the modular control architecture for a BEV, according to an embodiment of the disclosure. This multilayer structure, as a distributed approach in the modular control architecture of FIG. 1, in which global objectives are distributed into domain-specific smaller optimization tasks, forms a smart, or intelligent, thermal management (“Smart Thermal Management”), according to an embodiment of the disclosure. The multi-layered structure may include, for example and without being limited thereto, the subsystems captured by the elliptical outline in FIG. 1.

In FIG. 2, a layer 1 forms a lower control layer that acts directly on the actuators of the BEV and mainly includes basic functions of components to achieve target setpoints (PID control, control maps).

A layer 2 then consists of area-specific controls of subsystems. In the thermal system of a BEV, for example, it comprises the refrigerant, coolant and HVAC controls. Layer 1 and layer 2 together are considered in BEVs to belong to the core functionalities that are essential for the operation of the main functions of the vehicle.

More specifically, the disclosure and present embodiment relates to a coordination layer, shown as a layer 3 in FIG. 2. Predictive, i.e., anticipatory, inputs (hereinafter also referred to as system inputs) are used to improve accurate power and/or energy coordination. Thus, the layer 3 controller determines the heating and cooling requirements of the vehicle system (heat pump, electric powertrain, and interior air conditioning).

Layer 3 as shown, the global coordination performed by a global coordination device, is an essential element between remote area inputs and core vehicle functions. The goal of this control layer is to distribute power between the vehicle's major subsystems. The electric powertrain, heat pump system, and interior climate control are monitored simultaneously to ensure maximum driver satisfaction in terms of comfort, driving pleasure, and convenience, while reaching the destination with sufficient battery charge. The need for a coordination function in this phase is justified by the solution of a multi-objective problem, which consists in the optimal allocation of the finite amount of energy available in the battery, the only energy source in a BEV.

With respect to layer 3, the first step is to translate the driver's requirements (for example, input via a human-machine interface, HMI) into mathematical terms in order to arrive at a formulation of an optimal control task via a formulation of a target cost function. The target cost function contains a term for each of the target KPIs (driving pleasure, convenience, comfort) whose importance is weighted based on the HMI values. Specifically, the cost function terms represent the level of user satisfaction expressed as available energy versus energy demand in each of the subsystems for each of identified road segments.

Predictive information is processed in a layer 4. Using the data available in the vehicle, in the cloud, and in the navigation systems, advanced systems can predict the required energy trajectories in the vehicle for a given route, which includes energy demand computation performed by an energy demand computation device.

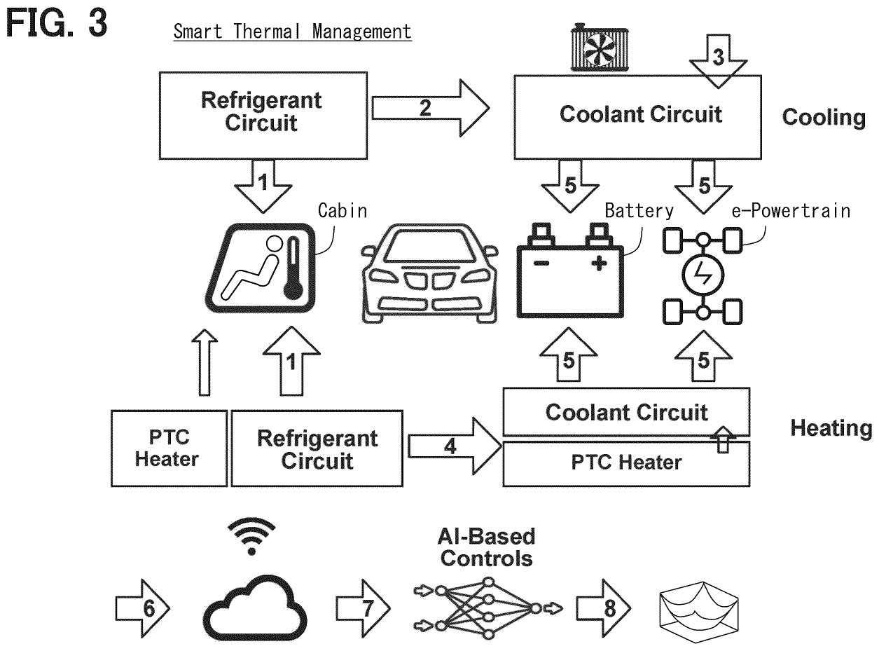

FIG. 3 shows an overview of smart thermal management in a BEV, according to an embodiment of the disclosure, and illustrates key concepts of smart thermal management in terms of improved vehicle performance based on high-performance components and latest prior art or state-of-the-art technologies.

According to FIG. 3, these essential concepts may include, but are not limited to: High performance components, such as improved cabin air conditioning (arrow 1), improved battery cooling (arrow 2), improved battery cooling by radiators (arrow 3), improved battery heating (arrow 4), improved coolant energy flow distribution (arrow 5); State-of-the-Art technology, such as accurate prediction using connectivity (arrow 6), global energy coordination of vehicles based on MPC methods (arrow 7), and/or Al-based thermal management through local optimization (arrow 8). In particular, in the present embodiment, global energy coordination of vehicles based on MPC methods (arrow 7) is considered.

Among the above essential concepts, the present embodiment particularly targets the part indicated by “arrow 7” in FIG. 3, i.e., global energy coordination in vehicles based on MPC (Model Predictive Control) methods.

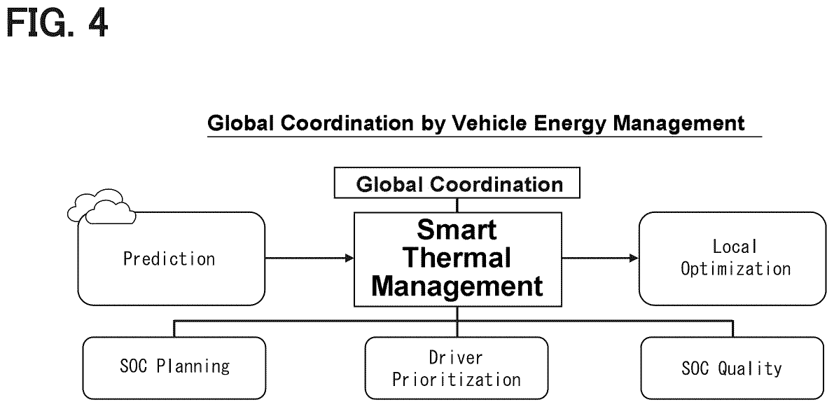

FIG. 4 shows an overview of a global coordination by vehicle energy management in a BEV, according to an embodiment of the disclosure, and further illustrates, according to layer 2 in FIG. 2, the global coordination by vehicle energy management and its individual components. With smart thermal management, the global coordination enables improved energy distribution into the areas of state of charge planning or SoC planning with the goal of avoiding a critical battery condition, prioritization by the user or driver with the goal of improving the user experience, and state of charge quality or SoC quality with the goal of providing an accurate state of charge estimate, and thus results in an improvement of the overall user experience.

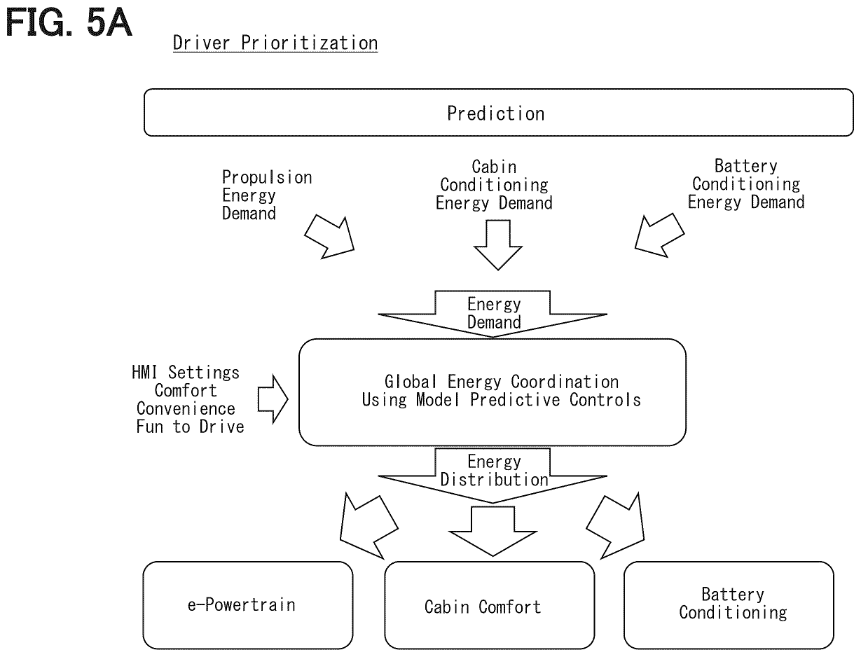

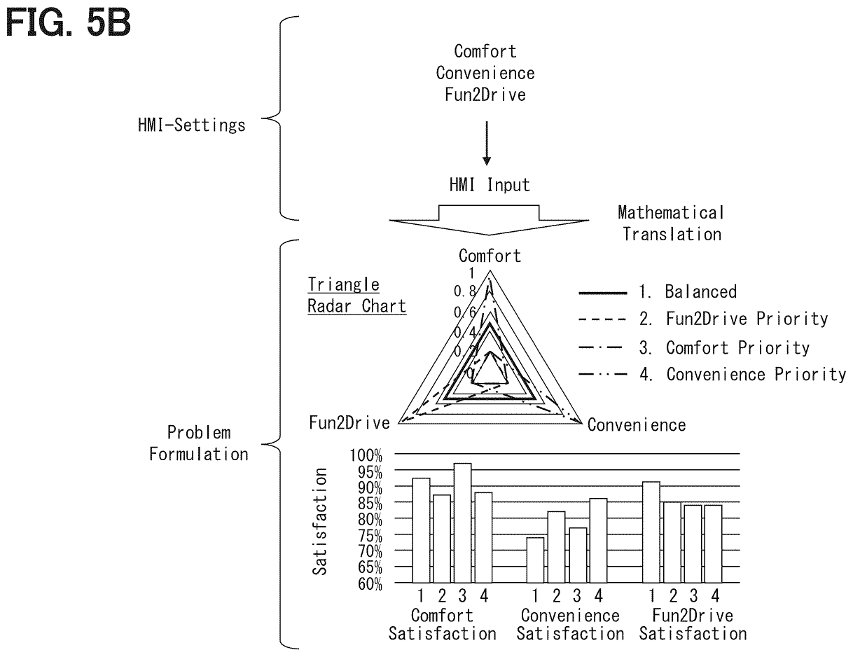

FIG. 5A illustrates a representation of global coordination with prioritization by a user or driver in a BEV, according to an embodiment of the disclosure, and further illustrates prioritization performable within the global coordination by the user or driver that allows a user or driver of the BEV to specify preferences for the global coordination.

Referring to FIG. 5A, a prediction or forecast of a propulsion energy demand, a cabin conditioning energy demand (cabin air conditioning), and a battery conditioning energy demand expected by the system along a predetermined route is performed, respectively. The system and/or the prediction may rely, for example and without being limited thereto, on data from the vehicle, data from the environment of the vehicle, data from the navigation system, data from the cloud, and the like. It is noted that, within the meaning of the present disclosure, a conditioning at a corresponding location may comprise at least a climatization at this location.

The predicted energy demands are then used to compute a (total) energy demand, which forms one of several system inputs to the global coordination.

In addition, via a human-machine interface (HMI), settings made by the user or driver, hereinafter also referred to as HMI settings or preferences, regarding comfort, convenience, and driving fun or pleasure, for example as user or driver preferences, enter the global coordination as another of several system inputs. As shown in FIG. 5B, comfort, driving pleasure and convenience, for example, can be parameterized via the HMI in the manner of a HMI input chart or radar chart, in FIG. 5B for example a triangle, with regard to balance, priority to driving pleasure, priority to comfort and priority to convenience, with effects, shifts and/or focal points in favor of or to the detriment of a respective (partial) user satisfaction that can be set, for example in percentages.

Global (energy) coordination is then performed using model predictive control, i.e., the aforementioned of MPC (Model Predictive Control) techniques, and as a result provides an energy distribution corresponding to the system inputs for distributing available energy from the BEV's battery to the requesting subsystems such as the electric powertrain (e-drive train), cabin conditioning (cabin comfort), and BEV battery conditioning.

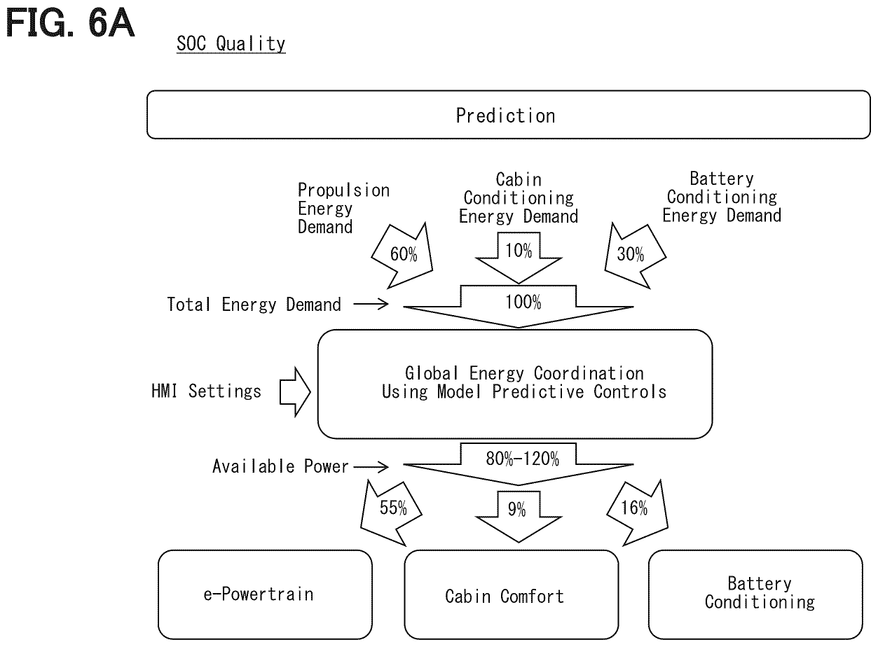

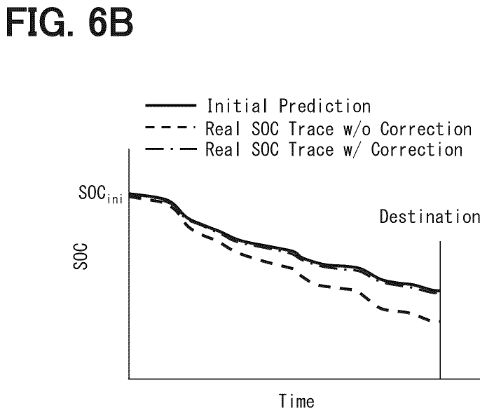

FIG. 6A shows another illustration of global coordination with prioritization in a BEV, according to an embodiment of the disclosure, and further illustrates an influence on the state of charge (SoC) quality that can be performed within the global coordination. In this context, the energy coordination improves the communication of information to the user or driver through corrections, more specifically through energy display corrections, through which more accurate, reliable information about the actual state of charge can be displayed to the driver.

As can be seen in FIG. 6A, the predicted total energy demand with, for example, a 60% propulsion energy demand, 10% cabin (air) conditioning energy demand, and 30% battery conditioning energy demand, enters into the global coordination at a total of 100%. This initial prediction is represented by the top line (“initial prediction”) in the state of charge diagram shown in FIG. 6B. An erroneous indication of the state of charge or state of charge progression results later, and as represented by the lowest line (“real SoC progression without correction”) in the state of charge diagram shown in FIG. 6B, from, for example, inaccuracies of models used and the like. The erroneous indication of the state of charge may cause false display. Coordination logic forming part of the global coordination corrects this erroneous indication of the state of charge to a value closer to the initial prediction, so that the indication of the state of charge represented as the middle line (“real SoC progression with correction”) in the state of charge diagram shown in FIG. 6B appears more reliable and consistent to the user or driver. The corrected indication of the state of charge can achieve accurate display. Energy coordination thus improves communication to the user or driver through power or energy corrections. In practice, depending on the actual amount of energy available, this may involve, for example, a slightly reduced actual energy distribution that deviates from the original energy requirements, such as 55% instead of 60% for the electric powertrain, 9% instead of 10% for cabin conditioning, and 16% instead of 30% for battery conditioning in the example shown.

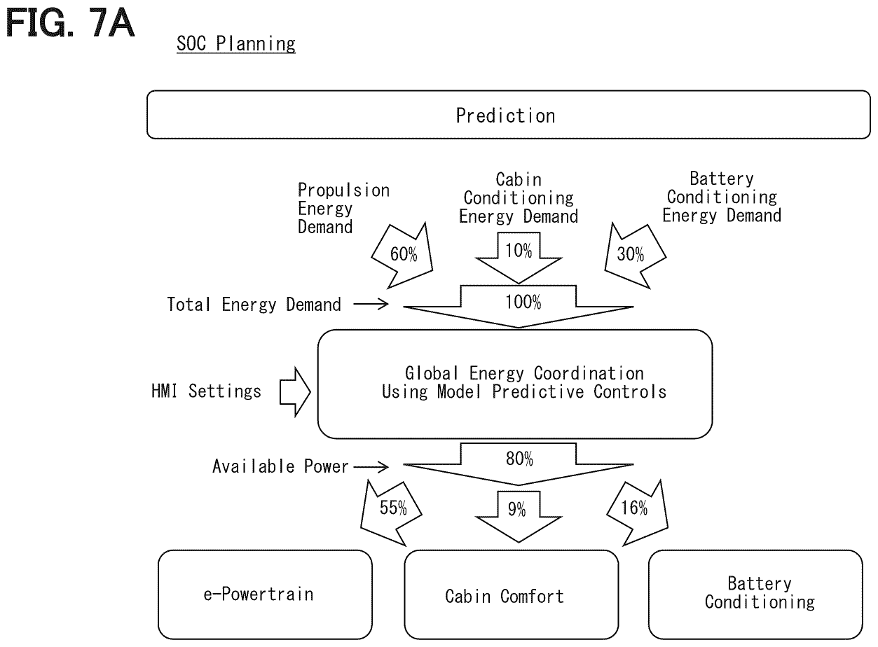

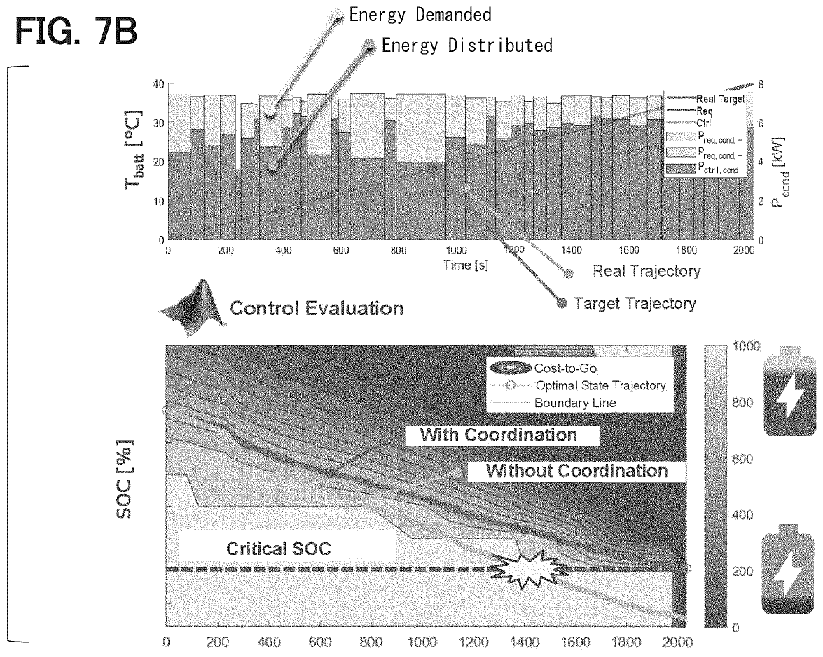

FIG. 7A shows an illustration of global coordination with prioritization in a BEV, according to an embodiment of the disclosure, and FIG. 7B on the top side illustrates a state of charge planning that can be performed within the global coordination. In this context, the state of charge planning avoids critical battery operation and optimizes towards reaching the destination to be approached.

In the above context, FIG. 7B on the bottom side shows an example of cost-to-go characteristics (cost-to-go map) and a computed optimal SoC trajectory. The state-of-charge or SoC value of the battery is at the limit of the infeasible range where user satisfaction can be maximized by keeping the final SoC value in the target interval for the final state.

As shown on the top side of FIG. 7B, this can be achieved, for example, by reducing the power requested for battery conditioning over preferably longer periods of time and without relevant effects on drive power and cabin air conditioning, e.g. using a suitable cost function (“cost-to-go”) to determine a trajectory for an optimum state, so that overall the real trajectory of provided energy or power is flatter than the target trajectory according to requested energy or power and accordingly, as shown on the bottom side of FIG. 7B, a critical state of charge that occurs prematurely without coordination does not occur or does not occur at all. power is flatter than the target trajectory according to the requested energy or power and, accordingly, as shown on the bottom side of FIG. 7B, a critical state of charge which occurs prematurely without coordination is not reached or not reached before the predetermined target is reached. The critical state of charge corresponds here, as described above, to a predetermined minimum allowable residual state of charge of the battery of the BEV. It is understood that the planning of the state of charge to prevent a critical state of charge from being reached too early is not limited to battery conditioning alone, and that changes to, for example, distribution to the electric powertrain and/or cabin conditioning can also be included and taken into account in the coordination to determine the trajectory for the optimal state.

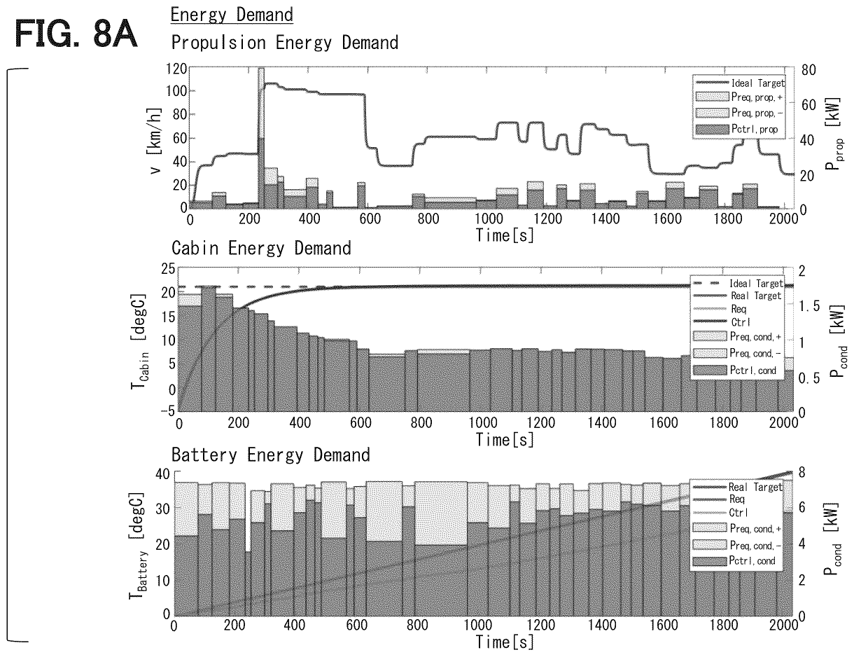

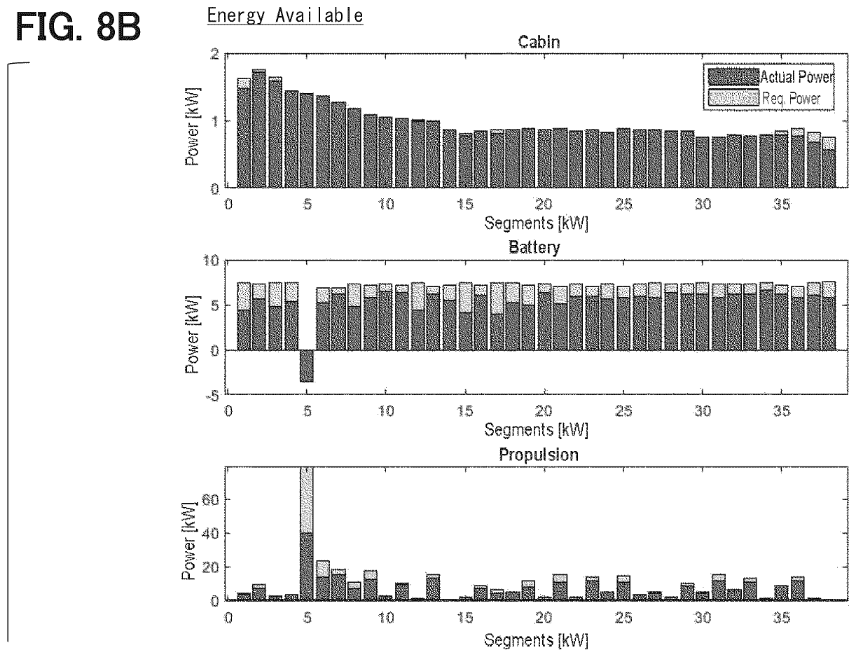

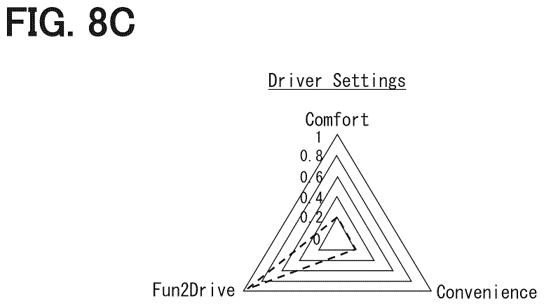

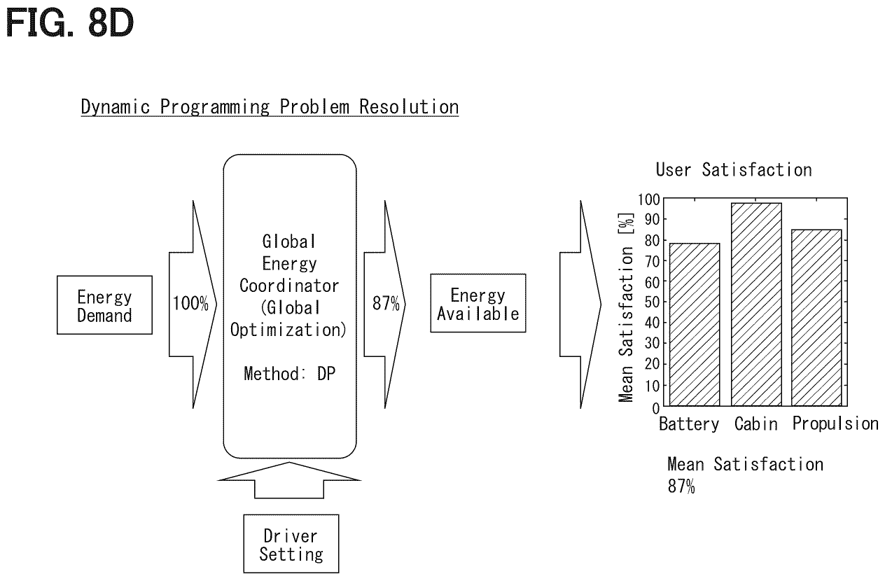

FIGS. 8A to 8D show illustrations of quantified benefits of global coordination in a BEV, according to an embodiment of the disclosure. For example, from the synopsis in FIG. 8A, it is apparent that according to the user or driver prioritization on “Fun to Drive,” shown in FIG. 8C which may include, for example, the desire for consistently comfortable cabin climate control while maintaining more than adequate propulsion power, the energy or power across all segments is largely equal to the requested energy or power, the energy or power distributed to the battery conditioning is kept below the requested energy or power across all segments, and the energy or power distributed to the cabin conditioning is approximately equal to the requested energy or power across all segments. In addition, it can be seen, for example, from a segment 5 in FIG. 8B, that the global coordination system-wide makes increased use of, in particular, short-time segments of strong deviations or jumps for optimization, which will generally go unnoticed by the driver and to that extent has a favorable effect on the overall energy balance of the global coordination. As a result, as also shown in FIG. 8D, user satisfaction remains high (87% in FIG. 8D), particularly in the cabin and powertrain areas, and overall, at least approximately balanced.

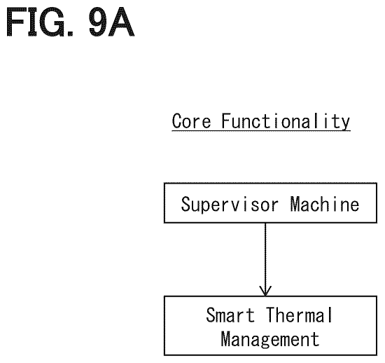

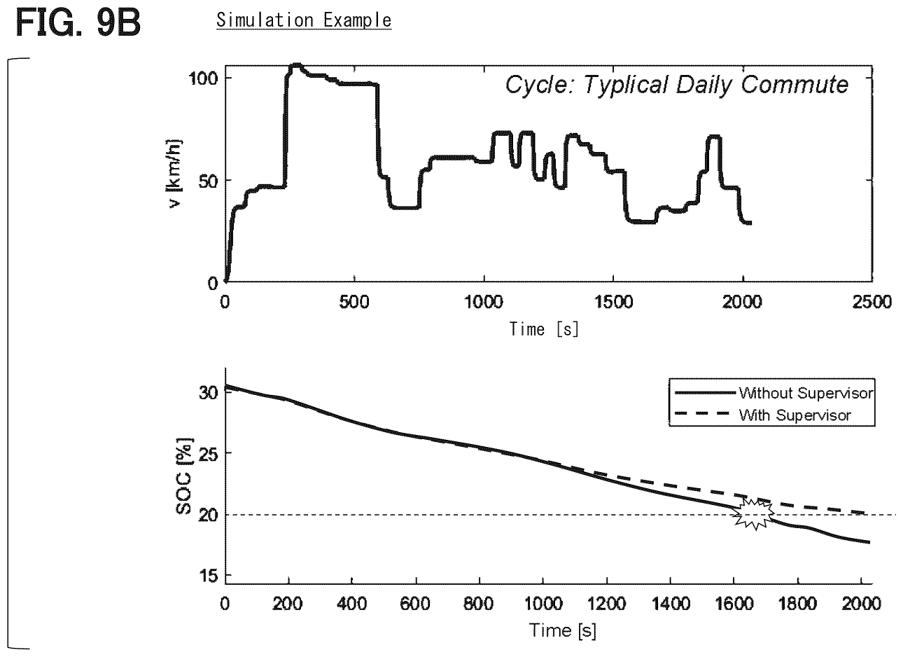

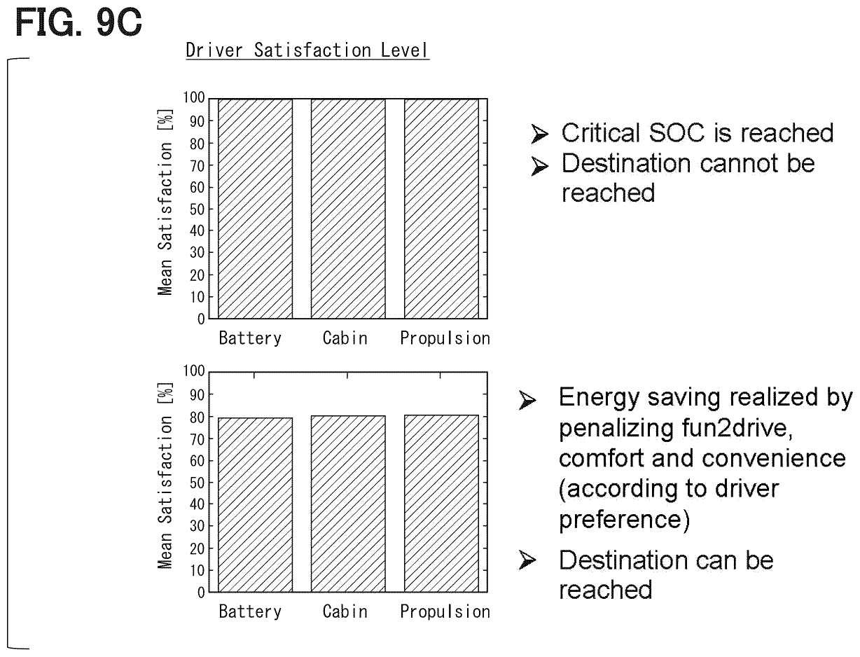

FIGS. 9A to 9C show another embodiment relating to an exemplary core functionality of global coordination with respect to avoiding a critical state of charge, according to an embodiment of the disclosure.

In this embodiment, a so-called supervisor machine is generated across the entire smart thermal management of the BEV as shown in FIG. 9A, with the goal of achieving optimal user or driver satisfaction while reducing energy. In this respect, the supervisor machine is to be understood in such a way that the (single) contexts illustrated in the preceding FIGS. 5A to 8D are collectively considered and processed in the supervisor machine. A simulation example shown in FIG. 9B indicates that the destination cannot be reached without supervisor. For example, as shown on the top side of FIG. 9C, if it is recognized that a critical state of charge is reached when aiming for 100% driver satisfaction level in all three areas of battery, cabin and propulsion and if the predetermined destination cannot be reached, then the supervisor machine provides effects on an energy saving at the expense of driving pleasure, comfort and/or convenience (according to user or driver preference) in such a way that the predetermined destination can be reached at the cost of reduced user satisfaction as shown on the bottom side of FIG. 9C. Therefore, optimal satisfaction can be achieved through the supervisor.

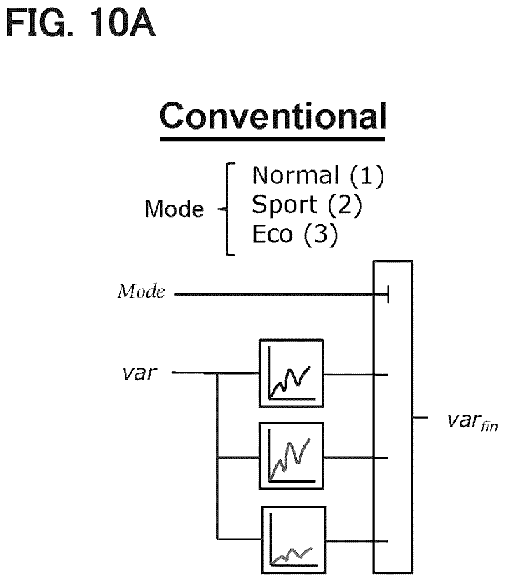

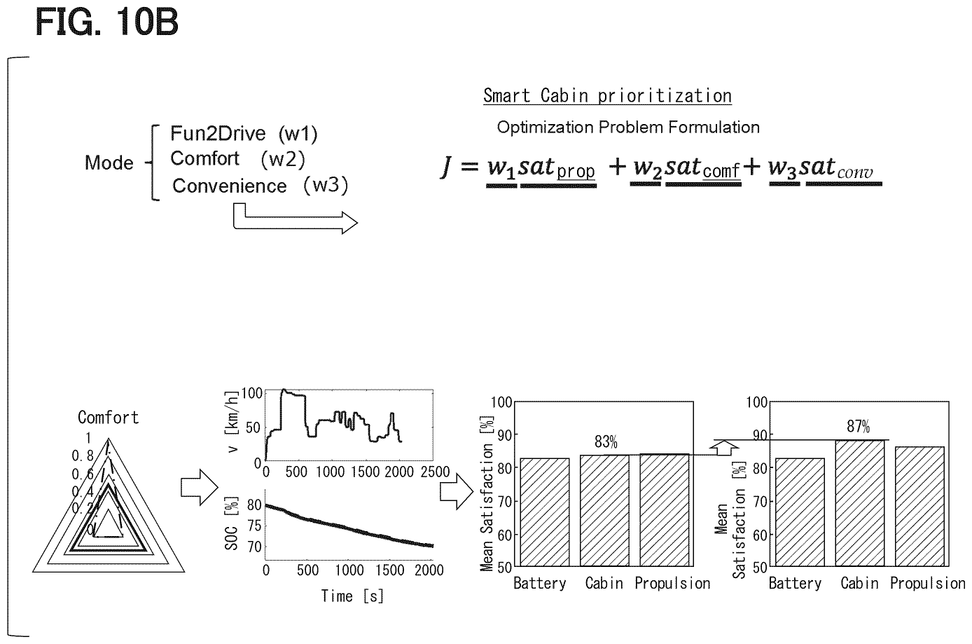

FIG. 10B shows a diagram relating to an exemplary smart cabin prioritization by global coordination, according to an embodiment of the disclosure.

In contrast to the prioritization known so far, which is based on look-up tables, characteristic curves or maps and the like as indicated in FIG. 10A and thus can only provide a limited prioritization, the smart cabin prioritization collectively relates the individual system inputs in a suitable manner according to the following optimization problem formula in Math. 1 in order to achieve a fully flexible and continuous optimization of driver or user satisfaction and to increase the driver's or user's perception of comfort:

J=w₁·satₚᵣₒₚ+w₂·sat_{comf}+w₃·sat_{conv} Math. 1
wherein J represents a resulting user satisfaction, w₁, w₂ and w₃ are respectively weighting factors predetermined according to, for example, driver-adjustable (driving) modes or prioritizations via the HMI, such as driving fun (w₁), comfort (w₂), and convenience (w₃) adjustable, for example, via the HMI, and satₚᵣₒₚ, sat_{comf}, and sat_{conv} are satisfaction rates for propulsion user satisfaction, comfort user satisfaction and electrical power from auxiliaries user satisfaction, respectively. A total user satisfaction may then be obtained by dividing all three together, i.e., satₚᵣₒₚ+sat_{comf}+sat_{conv}, by 3.

It is noted that the satisfaction rates satₚᵣₒₚ, sat_{comf}, and sat_{conv} may also be expressed as satₚᵣₒₚ, sat_{cab} and sat_{batt}, respectively, which are, in particular, the quotients shown in Math. 2 to 4 below of power (“P”) actually provided (“act”) and power requested (“req”) in each of the individual areas of powertrain (acceleration and recuperation control), cabin (cabin conditioning) and battery (battery conditioning):

$${sat}_{prop} = \frac{{P}_{act , prop}}{{P}_{req , prop}} \qquad Math . 2$$

$${sat}_{cab} = \frac{{P}_{act , cab}}{{P}_{req , cab}} \qquad Math . 3$$

$${sat}_{batt} = \frac{{P}_{act , batt}}{{P}_{req , batt}} \qquad Math . 4$$

As shown in FIG. 10B, in the present embodiment, using smart cabin prioritization with prioritization to, for example, “comfort” by the driver, the driver's comfort sensation rate can be increased by a substantial 4% from 83% to 87%. There is no restriction on this, however, and comparable increases are achievable for the remaining drive and battery conditioning subsystems or areas, or a corresponding combination thereof.

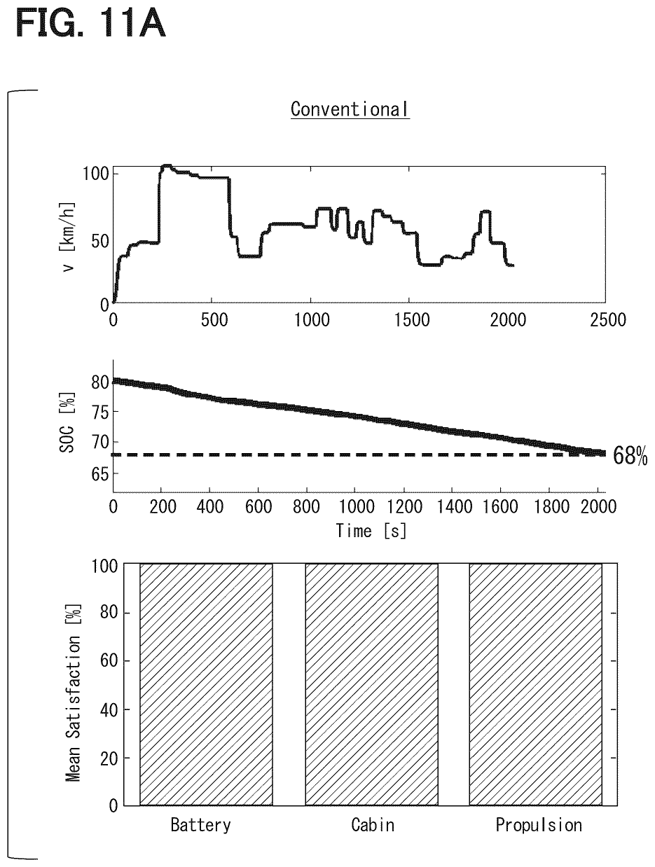

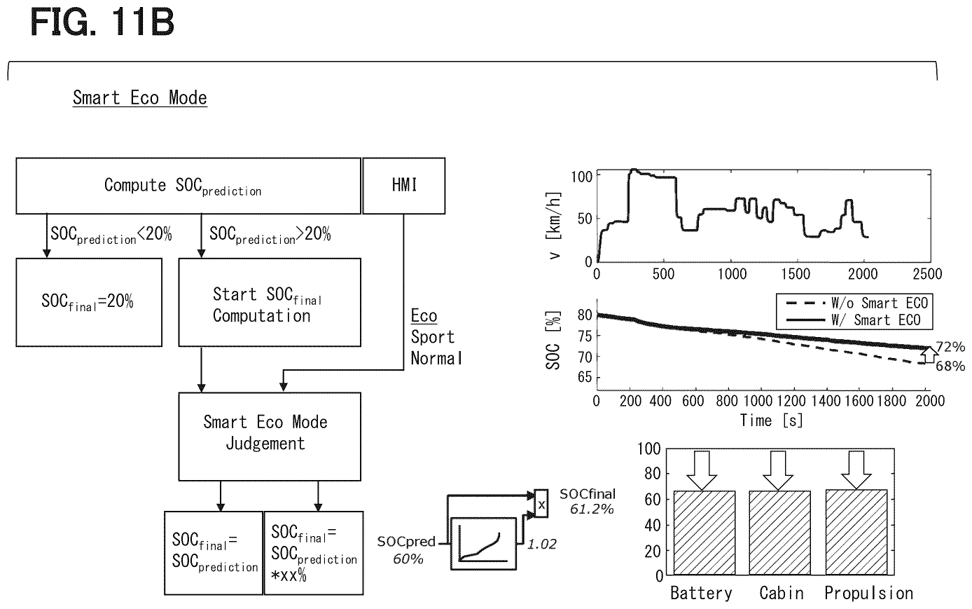

FIG. 11B shows an illustration to an exemplary smart ECO mode by global coordination, according to an embodiment of the disclosure.

With previously known prioritization that seeks to operate all (e.g., 3 compared to the present embodiment) major domains to satisfy requirements 100% using standard coordination logic with sufficient battery state of charge, as indicated in FIG. 11A, there is no additional benefit to, for example, BEV range when sufficient state of charge is available to satisfy requirements.

In contrast, a smart ECO mode according to the present embodiment enables energy savings by adjusting acceleration, battery conditioning, and comfort according to driver preference, which benefit additional range for the BEV. In other words, a smart introduction of energy saving in Eco mode is done by reducing the energy/power for e.g., heating/cooling the cabin and/or the battery and reducing the max. drive power (to a certain safe level), and by means of explicit prioritization, the driver can deliberately sacrifice power, battery conditioning, and comfort to gain additional range for the BEV.

In detail, a prediction of the state of charge is carried out as described above. If the prediction is already below 20% state of charge when the target is reached, a final state of charge (SOC_{final}) or target residual state of charge, which must not be fallen short of, is set at 20%, for example. If, on the other hand, the prediction is above 20% state of charge when the target is reached, in a computation of the final state of charge either the final state of charge is set equal to the predicted state of charge when the target is reached, or, if the activation of ECO mode via the HMI is determined by the driver or user, the predicted state of charge when the target is reached is multiplied by a predetermined or predeterminable percentage factor and set equal to the final state of charge not to fall below.

The global coordination then distributes the energy according to this final charge state, reduced according to the activated ECO mode, when the destination is reached, even though the destination would be reachable without the activated ECO mode, thereby creating additional range or range reserve for the BEV, as shown on the right side in FIG. 11B.

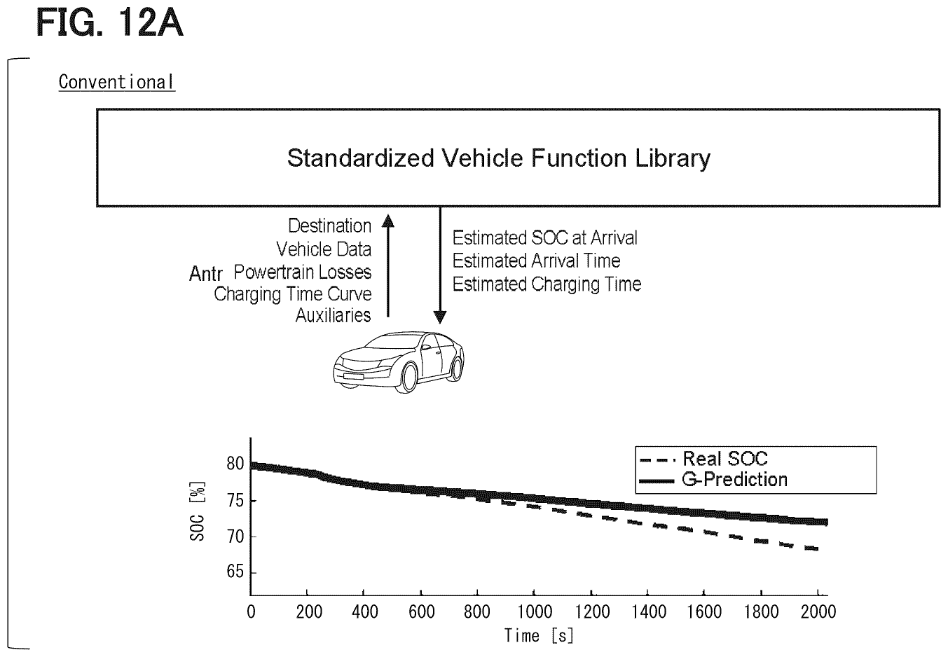

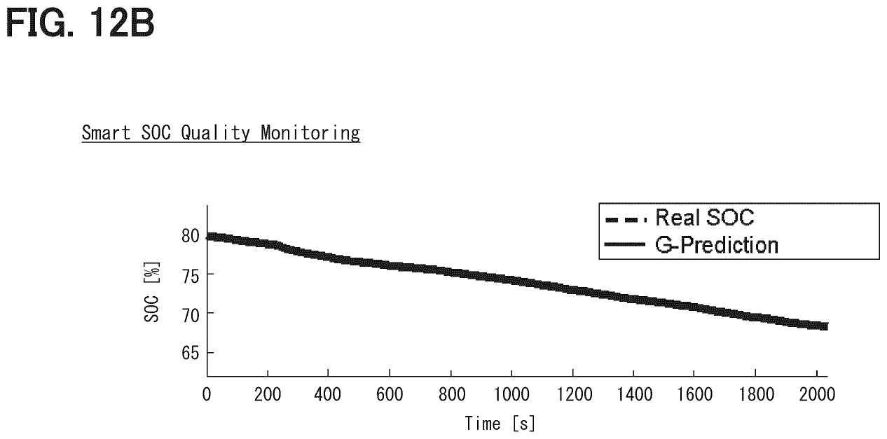

FIG. 12B shows an illustration to an exemplary state-of-charge state quality monitoring by global coordination, according to an embodiment of the disclosure.

With previously known state-of-charge quality monitoring, which can only provide an inaccurate prediction of the state-of-charge using standardized libraries of vehicle functions and thus only an oversimplified model, as indicated in FIG. 12A, the user experience deteriorates because the state-of-charge remaining predicted at the start of the journey is significantly higher than the value displayed to the driver or user at the destination when the destination is reached, for various reasons as indicated in FIG. 12A. For example, the state-of-charge (SOCₐᵣᵣᵢᵥₐₗ=72%) remaining predicted at the start of the journey may be significantly higher than the value (SOCₐᵣᵣᵢᵥₐₗ=68%) at the destination as shown in FIG. 12A. If the driver assumes that he or she will be able to reach another destination with the remaining state of charge displayed to him or her at the start of the trip, but then discovers along the way that this will not be possible without recharging due to the inaccurate prediction of the state of charge, dissatisfaction will set in for the driver.

In this embodiment, the smart state-of-charge quality monitoring causes the global coordination to adjust and control the power and/or energy allocation to the subsystems of the BEV such that, i.e. during the journey, for example, to compensate for losses, deviations, detour and the like by reducing the power and/or energy allocation to the subsystems in such a way that the state of charge displayed to the driver at the start of the journey does not change when the destination is reached, i.e. the same state of charge or final or residual state of charge (SoC_{final}) is still displayed to him at the destination. For example, the state-of-charge (SOCₐᵣᵣᵢᵥₐₗ=68%) remaining predicted at the start of the journey is substantially equal to the value (SOCₐᵣᵣᵢᵥₐₗ=68%) at the destination as shown in FIG. 12B. It is basically irrelevant how accurate the final state of charge displayed to the driver or user at the start of the journey is-to increase driver satisfaction, it is sufficient not to predict the final state of charge too high and not to have to change it to a lower value during the journey. This is because over-predicting the final state of charge results in reduced driver satisfaction (<100%), whereas under-estimating the final state of charge regularly results in increased driver satisfaction (>100%). Thus, state-of-charge quality monitoring reduces range anxiety for the BEV driver or user.

FIG. 13A shows definitions of input signals for or system inputs to global coordination, according to an embodiment of the disclosure.

More specifically, global coordination according to the present embodiment is preceded by an energy demand computation performed by the energy demand computation device for an energy consumption trajectory (energy consumption evolution or curve) along the route, at least one route energy demand prediction for the electric powertrain of the battery electric vehicle, where demanded energy is electrical energy, a route energy demand prediction for the cabin of the battery electric vehicle, where demanded energy is thermal energy, and/or a route energy demand prediction for the battery of the battery electric vehicle, where demanded energy is thermal energy.

In the power demand computation, based on the route power demand prediction and the vehicle speed, vehicle acceleration, and a gradient of a road, a vehicle model, which may include a model for the vehicle, transmission, electric motor generator, etc. generates an electric power demand (ePWT energy request) for the electric powertrain (P_{prop,req}) of the battery electric vehicle, which is associated with a battery temperature trajectory (T_{batt}) obtained, for example, by assuming that the battery temperature increases linearly over time and reaches a final value, as shown in FIG. 13C, and which enters the global coordination as a crucial system input.

Further, in the energy demand computation, based on the route energy demand prediction for the cabin, a cabin temperature trajectory generator then generates a cabin temperature trajectory based on an actual temperature of the cabin (T_{cab,act}) and a target temperature of the cabin (T_{cab}), which is obtained, for example, by suitable filtering with filter settings that affect T_{cab}, as shown in FIG. 13B. The cabin temperature trajectory, together with the ambient temperature (T_{amb}) and the vehicle speed (v), is fed to an inverse cabin thermal model, at the output of which is a cabin conditioning thermal power demand (P_{cab,req}), which, in conjunction with the vehicle speed, also enters the global coordination as a crucial system input.

Further, in the energy demand computation, based on the route energy demand prediction for the battery of the BEV, a battery temperature trajectory generator then generates the battery temperature trajectory (T_{batt}) based on an actual temperature of the battery (T_{batt},act) and a target temperature of the battery (T_{batt}), as shown in FIG. 13C. The battery temperature trajectory (T_{batt}), together with the vehicle speed (v), is fed to an inverse battery thermal model, the output of which is a battery conditioning thermal power demand (P_{batt,req}), which also enters the global coordination as another crucial system input.

It is noted that the vehicle model described above is replaceable by a simpler model or artificial intelligence (AI), and the inverse cabin thermal model and the inverse battery thermal model are each replaceable by an artificial intelligence (AI) or statistical model. The models used are not in themselves an essential subject matter of the embodiments described herein and are therefore not described in detail.

It is also noted that the conversion of thermal power/energy to electrical power/energy can be done in the power/energy demand computation or in the global coordination.

As a result, the global coordination, or a device executing the global coordination, thus has a plurality of system inputs, the plurality of system inputs including at least a cabin thermal energy trajectory based on environment conditions and temperature setting, an electrical energy trajectory based on vehicle specification (i.e., weight) and route, and a battery thermal energy trajectory based on battery thermal behavior and safety constraints (i.e., prevent excessive battery condition).

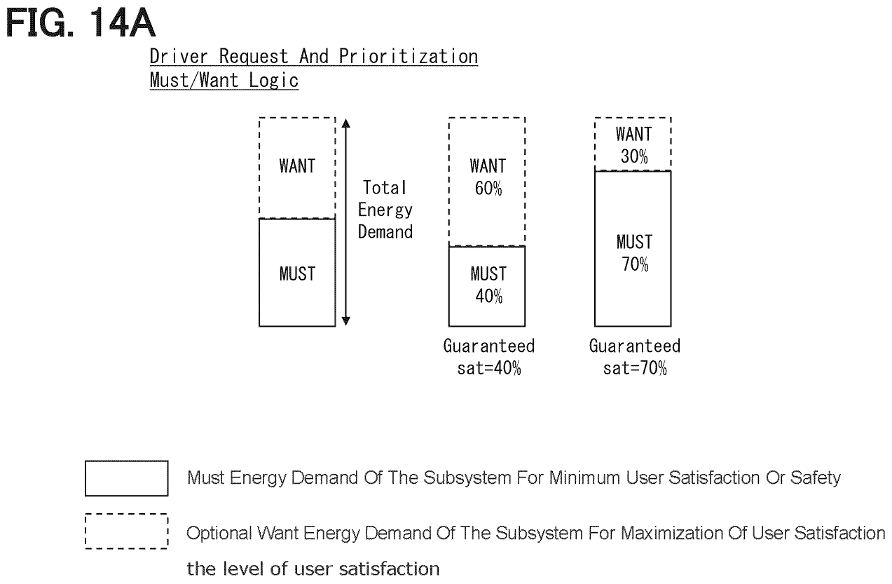

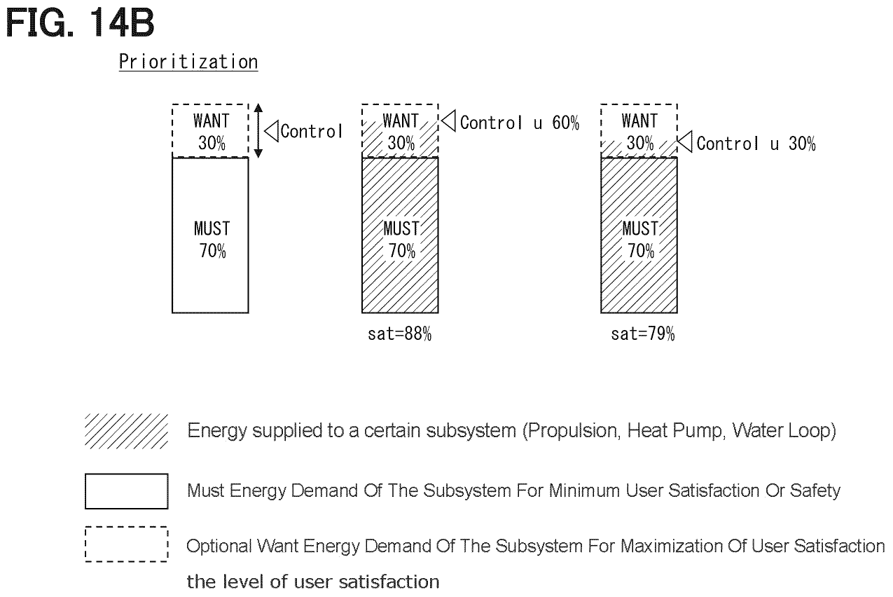

FIG. 14A shows an example definition of a cost function in global coordination, according to an embodiment of the disclosure.

Referring to FIG. 14A, a must/want logic in or as part of the (device for) global coordination ensures a certain minimum level of user satisfaction, where a target or goal energy requirement must be met, while an optional or desired energy requirement can be met. Examples of this are shown, without limitation, with corresponding must/want percentages or splits in FIG. 14A. A must/want split may be determined by calibration, or may be based on HMI prioritization inputs regarding (comfort, convenience, driving pleasure). In FIGS. 14A and 14B, the total height of each bar indicates a total energy demand at a certain subsystem including energy demands for propulsion, heat pump, and water loop.

Furthermore, the prioritization described above is directly linked to the computation of the global coordination cost function and defines, by means of dynamic weights, the importance of the different contributions in the cost function in Math. 5.

J(X,U,V)=w₁·satₚᵣₒₚ+w₂·sat_{comf}+w₃·sat_{conv} Math. 5
where J(X, U, W) represents the cost function, w₁, w₂, and w₃ respectively represent weights and weights, satₚᵣₒₚ represents user satisfaction in terms of propulsion, sat_{comf} represents user satisfaction in terms of comfort, and sat_{conv} represents user satisfaction in terms of electrical power from auxiliary sources, and where sat is the ratio of provided energy (Eₚᵣₒᵥ) and requested energy (E_{req}), and the provided energy is composed of target energy (Eₘᵤₛₜ) and desired energy (E_{want}) with corresponding factor u in Math. 6.

$$sat = \frac{{E}_{prov}}{{E}_{req}} = \frac{{E}_{must} + {uE}_{want}}{{E}_{req}} \qquad Math . 6$$

The relative comparison between the weights w₁, w₂ and w₃ is important here. As shown in FIG. 14B, the cost function controls, i.e., varies, the provision of desired energy (e.g., 60% of the same or 30% of the same) to the various subsystems in order to maximize the overall satisfaction of the user along the entire route by reaching the destination with sufficient charge.

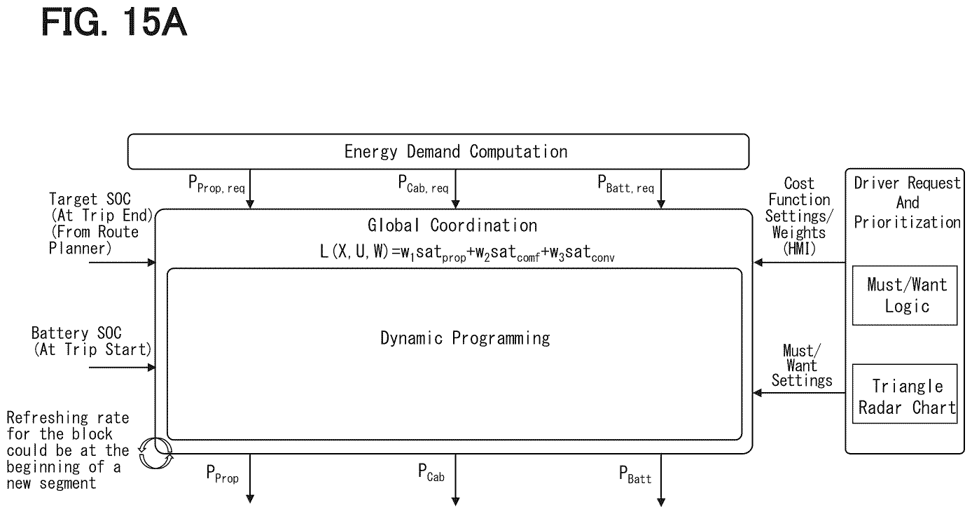

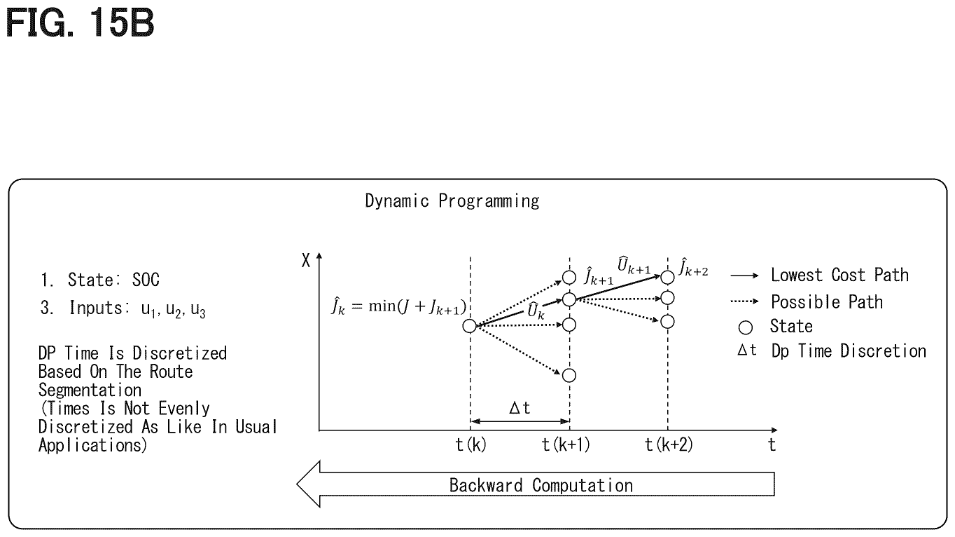

FIG. 15A shows an exemplary selection of an algorithm for global coordination, according to an embodiment of the disclosure.

Referring to FIG. 15A, which refers to and/or corresponds in part to the preceding figures, dynamic programming shown in FIG. 15B uses a forward computation and a backward computation to determine the least-cost state-of-charge trajectory for best satisfaction in accordance with the cost function.

More precisely, the computation of the available energy Pₚᵣₒₚ, P_{cab} and P_{Batt} for each subsystem of the BEV is performed in a dynamic programming framework. The optimization task represented by the cost function is solved backwards from the end point to the start point in the dynamic programming framework to ensure that the end state lies between the selected bounds. The optimal control direction line is computed by tracking the lowest cumulative cost over the entire path (cost-to-go characteristic; see FIG. 7B). The state and inputs are conveniently discretized, and to reduce computational cost, and the time domain is discretized based on segment duration (long and short segments yield the same computational cost).

As described above, layer 3, global coordination, shown in FIG. 2, is an essential element between remote area inputs and core vehicle functions. The goal of this control layer is to distribute power between the major subsystems of the vehicle. The electric powertrain, the heat pump system, and the interior climate control are simultaneously monitored to ensure maximum driver satisfaction in terms of comfort, driving pleasure, and convenience, while reaching the destination with sufficient battery charge. The need for a coordination function in this phase is justified by the solution of a multi-objective problem, which consists in the optimal allocation of the finite amount of energy available in the battery, the only energy source in a BEV.

With respect to layer 3, global coordination, and to solve the first and second technical challenges mentioned above, the first step is to translate the driver's requirements (for example, input via a human-machine interface, HMI) into mathematical terms in order to arrive at a formulation of an optimal control task via a formulation of a target cost function. The target cost function contains a term for each of the target KPIs (driving pleasure, convenience, comfort) whose importance is weighted based on the HMI values. Specifically, the cost function terms represent the level of user satisfaction expressed as available energy relative to energy demand in each of the subsystems for each of identified road segments.

In a second step, a selection of a most promising algorithm for optimal energy partitioning is made. A combination of classical model predictive control (MPC), dynamic programming (DP) and Pontryagin's minimum principle (PMP) was identified as the most popular algorithms for optimal energy partitioning. The foundation of dynamic programming makes the algorithm a good candidate for solving a multi-state, multi-input final state constrained problem.

The algorithm for computing the optimal control inputs can again be divided into four (algorithm) steps as described below.

In a first algorithm step, a computation of the energy demand of the subsystems is performed. Predictive inputs in combination with inverse submodels or data-driven models or statistical models or a combination thereof are used to compute the energy demand of the individual road segments that make up the entire trip. The predicted vehicle speed is used to compute the propulsion energy demand with a calibrated physical vehicle model that is corrected based on the user's driving style. Along with the propulsion energy requirement, the thermal energy required for the air conditioning system and battery is also computed to achieve cabin cooling/heating and battery cooling/heating, respectively.

In a second algorithm step, the formulation of the problem is performed. The optimal question is formulated to ensure maximum user satisfaction (in terms of driving pleasure, comfort and convenience) during the journey and to ensure arrival at the destination with a predefined minimum residual energy in the battery. The available energy is a function of the control inputs according to a must/want logic. The must/want logic always ensures a certain minimum level of available energy (and thus driver satisfaction). The must/want thresholds can be fixed or dynamic based on HMI inputs.

In a third algorithm step, the available energy Pₚᵣₒₚ (ePWT electrical power available), P_{cab} (cabin conditioning electrical power available) and P_{Batt} (battery conditioning electrical power available) for each subsystem is computed in a dynamic programming framework. The optimization task represented by the cost function is solved backwards from the end time to the start time in the dynamic programming framework to ensure that the end state lies between the selected bounds. The optimal control trajectory is computed by tracking the lowest cumulative cost over the entire trajectory (cost-to-go characteristic; cf. FIG. 7B; FIG. 7B shows an example of cost-to-go characteristics (cost-to-go map) and the computed optimal SoC trajectory in the above context. The SoC value of the battery is at the limit of the infeasible range where user satisfaction can be maximized by keeping the final SoC value in the target interval for the final state). The state and inputs are conveniently discretized, and to reduce computational overhead, the time domain is discretized based on segment duration (long and short segments yield the same computational overhead).

In a fourth algorithm step, optimal control inputs are activated. The available energy for each subsystem is used as a constraint for local optimization in each subsystem. Not all of the requested energy is provided to the coolant subsystem to reach the destination with the current SoC in the target range. With this constraint and optimization, optimal satisfaction is achieved, but at the cost of not fully achieving the target temperature curve.

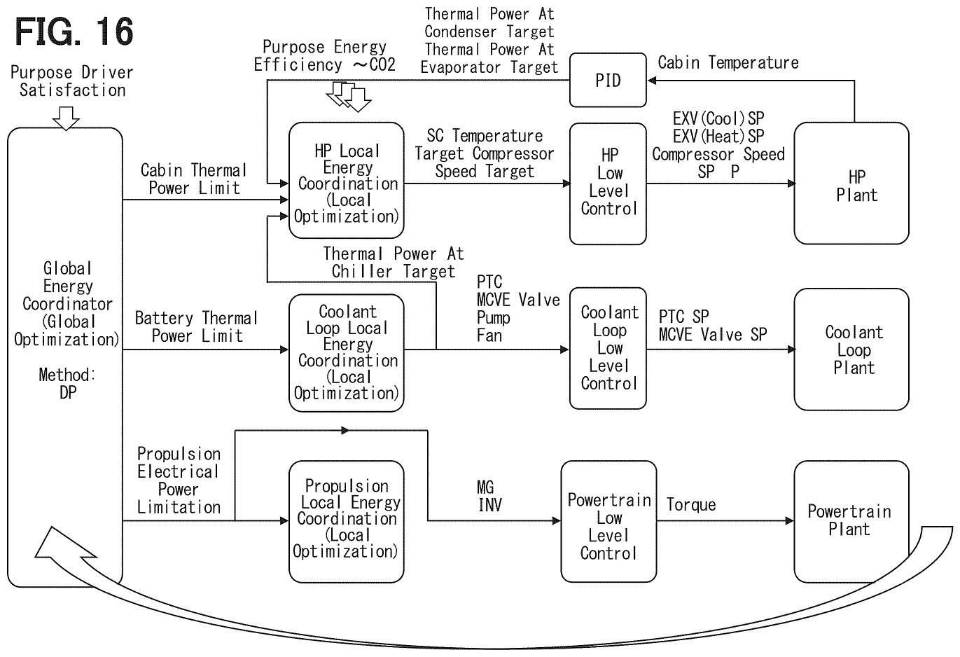

FIG. 16 is an illustrative diagram showing an exemplary implementation with connection of the global coordination to a local optimization layer in the BEV, according to an embodiment of the disclosure.

Modifications to the above embodiment provide various options and improvements.

The disclosure has been described with reference to a preferred embodiment. However, it is understood that the present disclosure is not limited to the specific embodiment described and may include and cover additional aspects, configurations, and modifications without departing from the scope of application of the described and claimed subject matter. Such additional aspects, configurations, and modifications may include, for example, a method, apparatus, device, system, computer program, and device for globally coordinating the distribution of energy between subsystems in a battery electric vehicle having a modular control architecture based on a computed energy consumption trajectory for a predetermined route of the battery electric vehicle.

In general, embodiments (e.g., the global coordination device and the energy demand computation device) of the disclosure may be implemented in hardware or special circuitry, software, logic, or any combination thereof. For example, some aspects may be implemented in hardware, while other aspects may be implemented in firmware or software that may be executed by a controller, microprocessor, or other computing device, although the disclosure is not limited thereto. While various aspects of the disclosure may be illustrated and described in the form of block diagrams, flowcharts, or other pictorial representations, it is understood that the blocks, devices, systems, techniques, or methods described herein may be implemented as non-limiting examples in hardware, software, firmware, special circuits or logic, general purpose hardware or controllers, or other computing devices, or any combination thereof.

Embodiments (e.g., the global coordination and the energy demand computation) of the present disclosure may be implemented by computer software executable by a data processor of a system unit, such as in the processor unit, or by hardware or by a combination of software and hardware. In this regard, it should be noted that blocks of logical flow shown in the figures may represent program steps or interconnected logical circuits, blocks, and functions, or a combination of program steps and logical circuits, blocks, and functions. The software can be stored on physical media such as memory chips or memory blocks implemented in the processor, on magnetic media such as hard disks or floppy disks, and on optical media such as DVD and its data variants, CD.

Memory can be of any type appropriate to the local technical environment and can be implemented with any appropriate data storage technology, e.g., semiconductor memory devices, magnetic memory devices and systems, optical memory devices and systems, read-only memory, and removable memory. Data processors may be of any type appropriate to the local technical environment and may include one or more general-purpose computers, special-purpose computers, microprocessors, digital signal processors (DSP), application-specific integrated circuits (ASIC), gate-level circuits, and processors based on a multi-core processor architecture as non-limiting examples.

Embodiments of the disclosures may be used in various components, such as integrated circuit modules. Integrated circuit design is, by and large, a highly automated process. Complex and powerful software tools are available for converting a logic-level design into a semiconductor circuit design that can be etched and formed on a semiconductor substrate.

Electronic Design Automation (EDA) programs and tools automatically route traces and place components on a semiconductor chip using proven design rules and libraries of pre-stored design modules. Once the design for a semiconductor circuit is complete, the resulting design can be transmitted in a standardized electronic format to a semiconductor manufacturing facility or “fab” for fabrication.

The description provided to this extent has provided, as an exemplary and non-limiting example, a complete and informative description of the exemplary embodiment of the present disclosure. However, various modifications and adaptations may become apparent to those skilled in the relevant technical field in view of the foregoing description when read in conjunction with the accompanying drawings and the appended claims. It is to be understood that all such and similar modifications of the gauges of the disclosure still fall within the scope of the disclosure as defined in the appended claims.

As described above, in a system having a means for globally coordinating the distribution of power among subsystems in a battery electric vehicle having a modular control architecture based on a computed power consumption trajectory for a predetermined route of the battery electric vehicle, the subsystems include at least an electric powertrain, a cooling system, and cabin air conditioning, the means for globally coordinating has a plurality of system inputs and is associated with a coordination system layer above an optimization system layer and a component control system layer, and the means for performing the global coordination is arranged to distribute energy or power available in a battery of the vehicle to the subsystems in a coordinated manner based on a coordination function using the system inputs based on a cost function considering a must/want target for energy to be provided to the subsystems via the optimization system layer so as to maximize a user satisfaction for a user of the vehicle while driving and at the same time reach a driving destination on the predetermined route with a predetermined remaining state of charge of the battery.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A system for global coordination of distribution of energy between subsystems in a battery electric vehicle having a modular control architecture based on a computed energy consumption trajectory for a predetermined route of the battery electric vehicle, the subsystems including at least an electric drive train, a cooling system and a cabin air conditioning system, the system comprising at least one processor with at least one memory storing computer program code executable by the at least one processor, the at least one processor configured to:
receive system inputs, the system inputs including at least a cabin thermal energy trajectory based on environment conditions and temperature setting, an electrical energy trajectory based on a vehicle specification and route, and a battery thermal energy trajectory based on battery thermal behavior and safety constraints;
implement a coordination system layer, an optimization system layer disposed below the coordination system layer, and a component control system layer associated with the subsystems and disposed below the optimization system layer, wherein the optimization system layer is configured to determine and optimize energy supply to the subsystems locally in the battery electric vehicle by intelligent thermal management while monitoring a respective state of the subsystems; and
distribute energy available in a battery of the battery electric vehicle on a basis of a coordination function using the system inputs based on a cost function taking into account a must/want specification for energy to be provided to the subsystems via the optimization system layer as coordinated electrical energy available for the electric drive train, electrical energy available for cabin conditioning and electrical energy available for battery conditioning to the subsystems in such a way that a) a user satisfaction comprising at least comfort, driving pleasure and/or convenience is maximized for a user or driver of the battery electric vehicle during journey and, at same time, b) a destination is reached on the predetermined route with a predetermined remaining state of charge of the battery of the battery electric vehicle.

2. The system according to claim 1, wherein
the system inputs further comprise:
a battery initial state of charge, which is a state of charge of the battery at beginning of a trip;
a battery final state of charge, which is the predetermined remaining state of charge of the battery when the destination is reached; and
settings and/or weighting factors for the cost function, wherein the settings and/or weighting factors are predetermined as a user preference and/or user prioritization via a human-machine interface, wherein
the must/want specification is predetermined as a user desire and/or a user prioritization via the human-machine interface.

3. The system according to claim 1, wherein
the at least one processor is configured to perform an energy demand computation for the energy trajectories along the route, the energy demand computation including:
a route energy demand prediction for an electric powertrain of the battery electric vehicle, wherein a demanded energy is electric energy;
a route energy demand prediction for a cabin of the battery electric vehicle, wherein a demanded energy is thermal energy; and/or
a route energy demand prediction for the battery of the battery electric vehicle, wherein a demanded energy is thermal energy.

4. The system according to claim 3, wherein
for the route energy demand prediction for the electric powertrain, the energy demand computation includes a vehicle model that generates an electric power demand for the electric powertrain of the battery electric vehicle based on a vehicle speed, a vehicle acceleration, and a gradient of a road, and
the energy demand computation includes inputting the electric power demand into the global coordination in conjunction with the battery thermal energy trajectory.

5. The system according to claim 3, wherein
for the route energy demand prediction for the cabin, the energy demand computation includes a cabin thermal energy trajectory generator that generates a cabin thermal energy trajectory based on an actual temperature of the cabin and a target temperature of the cabin; and
the energy demand computation includes feeding the cabin thermal energy trajectory, together with an ambient temperature and a vehicle speed, to an inverse cabin thermal model, and inputting an output of the inverse cabin thermal model as a cabin conditioning thermal power demand, in conjunction with the vehicle speed, into the global coordination.

6. The system according to claim 3, wherein
for the route energy demand prediction for the battery, the energy demand computation includes a battery thermal energy trajectory generator that generates the battery thermal energy trajectory based on an actual temperature of the battery and a target temperature of the battery; and
the energy demand computation includes feeding the battery thermal energy trajectory, together with a vehicle speed, to an inverse battery thermal model, and inputting an output of the inverse battery thermal model as a battery conditioning thermal power request into the global coordination.

7. The system according to claim 3, wherein
the at least one processor is configured to perform a conversion of thermal power to electrical power in the energy demand computation or in the global coordination.

8. The system according to claim 1, wherein
in the global coordination, the cost function involves optimization of a control task using a must/want logic, the cost function including a must portion to be provided to an energy requesting subsystem of the system to ensure a certain minimum level of user satisfaction, and a want portion to be optionally provided to the energy requesting subsystem to maximize a level of user satisfaction, and
a user prioritization is directly coupled to the cost function and defines, by dynamic weights, a meaning of different contributions in the cost function, the different contributions comprising at least a user satisfaction regarding comfort, propulsion and/or electrical performance of or for the subsystems of the battery electric vehicle during the use thereof.

9. The system according to claim 8, wherein
a split between the must portion and the want portion is determined by calibration or based on a predetermined prioritization regarding comfort, convenience, and/or driving pleasure.

10. The system according to claim 1, wherein
in the global coordination, the cost function is computed by dynamic programming, wherein the dynamic programming includes checking in a backward direction from an end time to an initial time whether a computed end state is achievable, and determining, based on the computed end state being achievable, in a forward direction from the initial time to the end time a loading state trajectory that provides user satisfaction at lowest cost in accordance with the cost function.

11. The system according to claim 1, wherein
the global coordination comprises a smart cabin prioritization predeterminable by a stronger comfort weighting by a driver at a human-machine interface, a smart eco mode limiting power for heating/cooling a cabin and maximum propulsion power, and/or a smart state-of-charge quality monitor arranged to correct an inaccurate state-of-charge prediction for reaching a destination to a more accurate value.

12. The system according to claim 1, wherein
the system comprises at least the battery provided in form of an energy storage device and arranged to store electric energy and to supply electric energy to the battery electric vehicle, and at least one heater, at least one refrigerant circuit, and at least one coolant circuit arranged to condition a cabin of the battery electric vehicle and to condition the battery and the electric drive train of the battery electric vehicle by heating and/or cooling.

13. A method for global coordination of distribution of energy between subsystems in a battery electric vehicle having a modular control architecture based on a computed energy consumption trajectory for a predetermined route of the battery electric vehicle, the subsystems including at least an electric drive train, a cooling system and a cabin air conditioning system, the method comprising:
receiving system inputs, the system inputs including at least a cabin thermal energy trajectory based on environment conditions and temperature setting, an electrical energy trajectory based on a vehicle specification and route, and a battery thermal energy trajectory based on battery thermal behavior and safety constraints;
implementing a coordination system layer, an optimization system layer disposed below the coordination system layer, and a component control system layer associated with the subsystems and disposed below the optimization system layer, wherein the implementing of the optimization system layer includes determining and optimizing energy supply to the subsystems locally in the battery electric vehicle by intelligent thermal management while monitoring a respective state of the subsystems; and
distributing energy available in a battery of the battery electric vehicle on a basis of a coordination function using the system inputs based on a cost function taking into account a must/want specification for energy to be provided to the subsystems via the optimization system layer as coordinated electrical energy available for the electric drive train, electrical energy available for cabin conditioning and electrical energy available for battery conditioning to the subsystems in such a way that a) a user satisfaction comprising at least comfort, driving pleasure and/or convenience is maximized for a user or driver of the battery electric vehicle during journey and, at same time, b) a destination is reached on the predetermined route with a predetermined remaining state of charge of the battery of the battery electric vehicle.

14. A non-transitory computer readable medium storing a program for global coordination of distribution of energy between subsystems in a battery electric vehicle having a modular control architecture based on a computed energy consumption trajectory for a predetermined route of the battery electric vehicle, the subsystems including at least an electric drive train, a cooling system and a cabin air conditioning system, the program comprising instructions configured to, when executed by at least one processor, cause the at least one processor to perform:
receiving system inputs, the system inputs including at least a cabin thermal energy trajectory based on environment conditions and temperature setting, an electrical energy trajectory based on a vehicle specification and route, and a battery thermal energy trajectory based on battery thermal behavior and safety constraints;
implementing a coordination system layer, an optimization system layer disposed below the coordination system layer, and a component control system layer associated with the subsystems and disposed below the optimization system layer, wherein the implementing of the optimization system layer includes determining and optimizing energy supply to the subsystems locally in the battery electric vehicle by intelligent thermal management while monitoring a respective state of the subsystems; and
distributing energy available in a battery of the battery electric vehicle on a basis of a coordination function using the system inputs based on a cost function taking into account a must/want specification for energy to be provided to the subsystems via the optimization system layer as coordinated electrical energy available for the electric drive train, electrical energy available for cabin conditioning and electrical energy available for battery conditioning to the subsystems in such a way that a) a user satisfaction comprising at least comfort, driving pleasure and/or convenience is maximized for a user or driver of the battery electric vehicle during journey and, at same time, b) a destination is reached on the predetermined route with a predetermined remaining state of charge of the battery of the battery electric vehicle.
